(19) United States
(12) Patent Application Publication
(10) Pub. No.: US 2008/0044798 A1
(43) Pub. Date: Feb. 21, 2008

(54) Personality test

(75) Inventor: Oimer Yisroel Furmanski, Beitar-Ellit (IL)

Correspondence Address: DARBY & DARBY P.C., P.O. BOX 770, Church Street Station, New York, NY, 10008-0770, US

(73) Assignee: Atzmi Knowledge Ltd., Jerusalem (IL)

(21) Appl. No.: 11/505,711

(22) Filed: Aug. 16, 2006

(51) Int. Cl. G09B 19/00

(52) U.S. Cl. 434/236

(57) ABSTRACT

A method of determining personality traits of an individual including presenting to an individual a multiplicity of icons formed of geometrical shapes, the icons solely or in combination representing a plurality of personality trait spectra, obtaining feedback from the individual as to the individual's preferences among the multiplicity of icons and based on the feedback obtained from the individual, determining the individual's position along at least some of the plurality of personality trait spectra.

### FIELD OF THE INVENTION

The present invention relates to personality tests.

### BACKGROUND OF THE INVENTION

The following published document is believed to represent the current state of the art:

Color quiz, www.colorquiz.com.

### SUMMARY OF THE INVENTION

The present invention seeks to provide an improved personality test.

There is thus provided in accordance with a preferred embodiment of the present invention a method of determining personality traits of an individual including presenting to an individual a multiplicity of icons formed of geometrical shapes, the icons solely or in combination representing a plurality of personality trait spectra, obtaining feedback from the individual as to the individual's preferences among the multiplicity of icons and based on the feedback obtained from the individual, determining the individual's position along at least some of the plurality of personality trait spectra.

In accordance with a preferred embodiment of the present invention the multiplicity of icons vary in at least one of shape, size and color. Preferably, the presenting includes presenting via a visual display. Additionally or alternatively, the presenting includes presenting via a computer network.

In accordance with another preferred embodiment of the present invention the obtaining includes communicating the feedback via a computer network. Preferably, the determining includes analyzing the feedback at a location remote from the individual via a computer network. Additionally or alternatively, the determining includes analyzing the feedback at a location in propinquity to the individual using a computer connected to a display which is employed in the presenting.

In accordance with yet another preferred embodiment of the present invention the multiplicity of icons includes circular icons which relate generally to a first plurality of personality trait spectra and non-circular icons which relate generally to a second plurality of personality trait spectra, different from the first plurality of personality trait spectra. Preferably, the first plurality of personality trait spectra include at least two of will power; time efficiency; sincerity; faith; ambition; obedience; happiness; and satisfaction. Additionally or alternatively, the second plurality of personality trait spectra include at least two of inventiveness; analytical ability; ability to love; compassion; confidence; appreciation; honesty; adherence to values; and discipline.

There is also provided in accordance with another preferred embodiment of the present invention a test for determining personality traits of an individual including a display including a multiplicity of icons formed of geometrical shapes, the icons solely or in combination representing a plurality of personality trait spectra, feedback functionality operative to obtain feedback from the individual as to the individual's preferences among the multiplicity of icons and feedback analysis functionality operative, based on the feedback obtained from the individual, to determine the individual's position along at least some of the plurality of personality trait spectra.

In accordance with a preferred embodiment of the present invention the multiplicity of icons vary in at least one of shape, size and color. Preferably, the display is a computer driven display. Additionally or alternatively, at least one of the feedback functionality and the feedback analysis functionality employs a computer network.

In accordance with another preferred embodiment of the present invention the feedback functionality communicates with the feedback analysis functionality via a computer network. Preferably, the feedback analysis functionality is located remotely from the individual and communicates with the individual via a computer network. Additionally or alternatively, the feedback analysis functionality is located in propinquity to the individual and employs a computer associated with the display.

There is further provided in accordance with a further preferred embodiment of the present invention a visual presentation useful in determining personality traits of an individual including a display of a multiplicity of icons formed of geometrical shapes, the icons solely or in combination representing a plurality of personality trait spectra, the display being viewable by an individual who is enabled to provide feedback as to the individual's preferences among the multiplicity of icons, which feedback is useful to determine the individual's position along at least some of the plurality of personality trait spectra.

In accordance with a preferred embodiment of the present invention the multiplicity of icons vary in at least one of shape, size and color.

In accordance with a further preferred embodiment of the present invention the multiplicity of icons includes at least one of the following icons:

a first icon in the shape of a hollow gray circle, the first icon relating to at least one of a personality trait spectrum representing faith in the abstract, a personality trait spectrum representing devotion and adherence to ideals, a personality trait spectrum representing simplicity in perception and a personality trait spectrum representing freedom and independence of choice;

a second icon in the shape of a pair of hollow, dark blue isosceles triangles arranged with their bases parallel to one another and their peaks adjacent one another, the second icon relating to a personality trait spectrum representing satisfaction;

a third icon in the shape of a hollow red square, offset at a 45 degree angle from the horizontal, the third icon relating to a personality trait spectrum representing happiness;

a fourth icon in the shape of a hollow blue circle, surrounded by a plurality of blue squares forming a second circle, the fourth icon relating to a personality trait spectrum representing self-fulfillment;

a fifth icon in the shape of a hollow black square, the fifth icon relating to a personality trait spectrum representing the ability to identify and connect with things of importance or value, to define personal goals accordingly and to undertake the achievement of these goals;

a sixth icon in the shape of a hollow yellow circle, in which is nested a red circle, divided by yellow radii into twelve equal portions and having a black dot as its center, the sixth icon relating to a personality trait spectrum representing ambition and will power;

a seventh icon in the shape of a pair of large isosceles triangles, each of the large isosceles triangles including nine small, hollow, isosceles triangles, the nine isosceles triangles including three blue isosceles triangles, arranged along the bases of the large isosceles triangles, three dark blue isosceles triangles forming the upper boundaries of each of the large isosceles triangles and three purple isosceles triangles, the large isosceles triangles being arranged with their bases parallel to one another and their peaks adjacent one another, the seventh icon relating to at least one of a personality trait spectrum representing intellectual originality and inventiveness and originality of abstract thinking, a personality trait spectrum of associative and correlative thinking in the abstract and a personality trait spectrum of flexibility of thinking with respect to abstract ideas;

an eighth icon in the shape of a pair of large isosceles triangles, each of the large isosceles triangles including nine small, hollow, isosceles triangles, each of the nine isosceles triangles being of a different color, the large isosceles triangles being arranged with their bases parallel to one another and their peaks adjacent one another, the eighth icon relating to at least one of a personality trait spectrum representing intellectual originality and inventiveness and originality of practical thinking, a personality trait spectrum of associative and correlative thinking related to practical matters, a personality trait spectrum of flexibility of thinking with respect to practical ideas and topics and a personality trait spectrum of intuitive decisiveness and the ability to provide intuitive arguments to support a decision made;

a ninth icon in the shape of a plurality of nested hollow squares, offset at a 45 degree angle from the horizontal and sharing a common center, the nested hollow squares being in various shades of red and orange, such that outer squares are in darker shades and inner squares are in lighter shades, each pair of adjacent ones of the plurality of squares being separated by a white square, the ninth icon relating to at least one of a personality trait spectrum representing analytical skills in the abstract;

a tenth icon in the shape of a plurality of nested hollow squares, offset at a 45 degree angle from the horizontal and sharing a common center, each of the plurality of squares being a different color such that pairs of adjacent ones of the plurality of squares being separated by a white square, the tenth icon relating to at least one of a personality trait spectrum representing analytical skills when faced with practical problems and a personality trait spectrum of logical and rational decisiveness and the ability to provide rational arguments to support a decision made;

an eleventh icon in the shape of a large square formed of sixteen small, hollow squares, including twelve black squares arranged along the edges of the large square and four yellow squares disposed in the center of the large square, the eleventh icon relating to a personality trait spectrum of cognitive acknowledgment and acceptance of moral values and of their importance;

a twelfth icon in the shape of a large square formed of sixteen small, hollow squares, including twelve squares in various shades of gray arranged along the edges of the large square, two red squares and two blue squares, the twelfth icon relating to at least one of a personality trait spectrum of the ability to carry out the decisions made, regardless of their origin and a personality trait spectrum of the ability to live by moral values and to change one's lifestyle to conform to such moral values;

a thirteenth icon in the shape of a plurality of nested hollow squares, offset at a 45 degree angle from the horizontal and sharing a common center, arranged such that an outermost square is brown, a next outermost square is maroon, a middle square is red, an innermost square is dark blue and a next innermost square is gray, each pair of ones of the plurality of squares being separated by a white square, the thirteenth icon relating to a personality trait spectrum representing wealth of intellectual vocabulary and the ability to use the vocabulary at ease;

a fourteenth icon in the shape of a plurality of nested squares, offset at a 45 degree angle from the horizontal and sharing a common center, each of the nested squares being of a different color, the fourteenth icon relating to at least one of a personality trait spectrum representing love and affection and a personality trait spectrum representing kindness and good-heartedness;

a fifteenth icon in the shape of a large square formed of sixteen smaller squares, divided into four equi-size groups of squares of the same color, the groups including dark red, red, dark pink and light pink groups, the large square being arranged such that each row and each column of the large square includes a single representative from each of the groups, the fifteenth icon relating to at least one of a personality trait spectrum representing emotional self-control, a personality trait spectrum representing constructive rewarding and punishing in a proportionate manner and a personality trait spectrum representing courage and bravery;

a sixteenth icon in the shape of a pair of large isosceles triangles, each including nine small, isosceles triangles, including three light yellow isosceles triangles defining the base of each of the large triangles, three intermediate yellow isosceles triangles defining the upper boundaries of each of the large isosceles triangles and three dark yellow isosceles triangles, the large isosceles triangles being arranged with their bases parallel to one another and their peaks adjacent one another, the sixteenth icon relating to a personality trait spectrum representing compassion, mercy and empathy;

a seventeenth icon in the shape of a large square formed of sixteen smaller squares, divided into four equi-size groups of squares of the same color, the groups including squares in four shades of purple, the large square being arranged such that each row and each column of the large square includes a single representative from each of the groups, the seventeenth icon relating to at least one of a personality trait spectrum representing confidence and a personality trait spectrum of the ability to define, be attracted to and identify good and/or proper habits for oneself;

an eighteenth icon in the shape of a pair of large isosceles triangles, each including nine small, isosceles triangles including three light orange isosceles triangles defining the base of each of the large triangles, three dark orange isosceles triangles defining the upper boundaries of each of the large isosceles triangles and three intermediate orange isosceles triangles, the large isosceles triangles being arranged with their bases parallel to one another and their peaks adjacent one another, the eighteenth icon relating to at least one of a personality trait spectrum representing internal peace, quiet and calmness, a personality trait spectrum representing the abilities of thanking, appreciating, admitting, acknowledging and giving credit, a personality trait spectrum representing dependence and addiction and a personality trait spectrum of flexibility and openness to change of habits and ease of adoption of new habits;

a nineteenth icon in the shape of a plurality of nested squares, offset at a 45 degree angle from the horizontal and sharing a common center, the squares being in various shades of green such that outer squares are in darker shades of green and inner squares are in lighter shades of green, the nineteenth icon relating to at least one of a personality trait spectrum representing personal honesty and integrity, a personality trait spectrum representing the abilities of forming stable and permanent personal relationships having peace and harmony and a personality trait spectrum of the ability to preserve and permanently maintain habits;

a twentieth icon in the shape of a pair of large isosceles triangles, each including nine small isosceles triangles, each being in a different color, the large isosceles triangles being arranged such that their bases are parallel to one another, and their peaks are adjacent one another, the twentieth icon relating to at least one of a personality trait spectrum representing natural emotional openness and a personality trait spectrum representing proper orientation, conduct and drive in marital connections and relationships of women;

a twenty-first icon in the shape of a plurality of nested circles sharing a common center, each being a different color, the twenty-first icon relating to at least one of a personality trait spectrum representing expressiveness and wealth of vocabulary available to speech, a personality trait spectrum representing orientation, direction, motivation and drive for actions and a personality trait spectrum representing proper orientation, conduct and drive in marital connections and relationships of men;

a twenty-second icon in the shape of a plurality of nested circles in various shades of brown, which share a common center, arranged such that outer circles are in darker shades of brown and inner circles are in lighter shades of brown, the twenty-second icon relating to a personality trait spectrum representing humility and obedience;

a twenty-third icon in the shape of a plurality of nested hollow circles, which share a common center, arranged such that an outermost circle is brown, a next circle is maroon, a middle circle is red, an innermost circle is dark blue and a next innermost circle is gray, each pair of adjacent ones of the circles being separated by a white circle, the twenty-third icon relating to a personality trait spectrum representing focus and control of thought;

a twenty-fourth icon in the shape of a plurality of nested hollow circles of different colors, which share a common center and which are arranged such that each pair of adjacent ones of the plurality of circles is separated by a white circle, the twenty-fourth icon relating to a personality trait spectrum representing behavior of speech;

a twenty-fifth icon in the shape of a plurality of nested hollow circles in various shades of brown, which share a common center and are arranged such that outer circles are in darker shades of brown and inner circles are in lighter shades of brown, each pair of adjacent ones of the plurality of circles being separated by a white circle, the twenty-fifth icon relating to a personality trait spectrum representing behavior of actions;

a twenty-sixth icon in the shape of a pair of isosceles triangles, one being purple and the other being yellow, arranged along a common base to define a square offset at a 45 degree angle from the horizontal and symmetrical about a vertical axis extending between the peaks of the isosceles triangles, the twenty-sixth icon relating to a personality trait spectrum representing the sense of conversation;

a twenty-seventh icon in the shape of a pair of isosceles triangles, one being red and the other being yellow, arranged along a common base to define a square offset at a 45 degree angle from the horizontal and symmetrical about a horizontal axis extending between the peaks of the isosceles triangles, the twenty-seventh icon relating to a personality trait spectrum representing the sense of contemplation;

a twenty-eighth icon in the shape of a pair of isosceles triangles, one being orange and the other being yellow, arranged with their bases parallel to one another and their peaks adjacent one another, the twenty-eighth icon relating to a personality trait spectrum representing the sense of motion;

a twenty-ninth icon in the shape of a pair of isosceles triangles, one being purple and the other being blue, arranged with their bases parallel to one another and their peaks adjacent one another, the twenty-ninth icon relating to a personality trait spectrum representing the sense of realistic vision and sight;

a thirtieth icon in the shape of a pair of rectangles, one being yellow and the other being blue, arranged along a common edge to define a square which is symmetrical about a horizontal axis extending through its center, the thirtieth icon relating to a personality trait spectrum representing optimism;

a thirty-first icon in the shape of a pair of rectangles, one being blue and the other being orange, arranged along a common edge to define a square which is symmetrical about a vertical axis extending through its center, the thirty-first icon relating to a personality trait spectrum representing the ability of correction and solving of problems;

a thirty-second icon in the shape of a pair of isosceles triangles, one being purple and the other being green, arranged with their bases parallel to one another and their peaks adjacent one another, the thirty-second icon relating to a personality trait spectrum representing the ability to push things forward;

a thirty-third icon in the shape of a pair of isosceles triangles, one being blue and the other being green, arranged along a common base to define a square offset at a 45 degree angle from the horizontal and symmetrical about a horizontal axis extending between the peaks of the isosceles triangles, the thirty-third icon relating to a personality trait spectrum representing the sense of timing;

a thirty-fourth icon in the shape of a pair of rectangles, one being green and the other being orange, arranged along a common edge to define a square which is symmetrical about a vertical axis extending through its center, the thirty-fourth icon relating to a personality trait spectrum representing the ability to influence others; a thirty-fifth icon in the shape of a pair of rectangles, one being purple and the other being red, arranged along a common edge to define a square which is symmetrical about a vertical axis extending through its center, the thirty-fifth icon to a personality trait spectrum representing the ability to identify negative points in one's surroundings and to define the negative points as challenges to be tackled and wrestled with;

a thirty-sixth icon in the shape of a pair of large isosceles triangles, each being divided vertically into a pair of small isosceles triangles, one of which is green and the other is red, the large isosceles triangles being arranged with their bases parallel to one another and their peaks adjacent one another, the thirty-sixth icon relating to a personality trait spectrum representing the ability to identify the proper purpose and use of things in the world, and to use the things accordingly; and

a thirty-seventh icon in the shape of a pair of isosceles triangles, one being red and the other being orange, arranged along a common base to define a square offset at a 45 degree angle from the horizontal and symmetrical about a vertical axis extending between the peaks of the isosceles triangles, the thirty-seventh icon relating to a personality trait spectrum representing the ability to completely change one's personal, social and national reality by leading a revolutionary change in one's life.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present invention will be understood and appreciated more fully from the following detailed description, taken in conjunction with the drawings in which:

FIG. 1 is an illustration of a colored shape personality test page which is constructed and used in accordance with a preferred embodiment of the present invention.

### DETAILED DESCRIPTION OF PREFERRED EMBODIMENTS

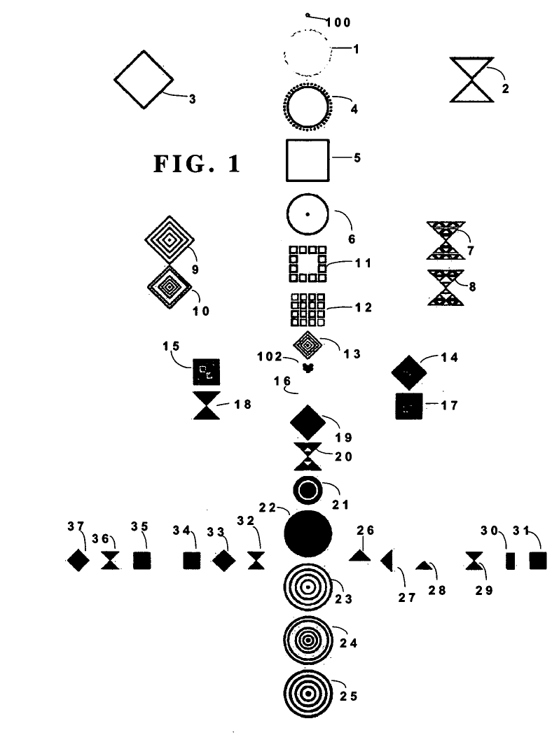

Reference is now made to FIG. 1, which is an illustration of a colored shape personality test page which is constructed and operative in accordance with a preferred embodiment of the present invention. As seen in FIG. 1, the personality test page includes a plurality of icons having various geometrical shapes and colors, which are arranged in a predetermined order. Each of the icons relates to one or more personality traits, and various groups of the icons represent additional personality traits.

In accordance with a preferred embodiment of the present invention the personality test determines personality traits of an individual by presenting to an individual a multiplicity of icons formed of geometrical shapes, the icons solely or in combination representing a plurality of personality trait spectra; obtaining feedback from the individual as to the individual's preferences among the multiplicity of icons; and based on the feedback obtained from the individual, determining the individual's position along at least some of the plurality of personality trait spectra.

When conducting a personality test according to the present invention, a subject being tested is presented with a visual display including a multiplicity of icons and is asked to rank each of the icons according to his reaction to each of the icons. The ranking preferably is in the range of −2 to 2, where −2 and −1 respectively indicate a higher level and a lower level of aversion to the icon, 2 and 1 respectively indicate a higher level and a lower level of affinity to the icon, and 0 indicates indifference to the icon. The personality traits of the tested person are then determined based on his ranking of the various icons and/or on his ranking of subgroups of icons.

In one embodiment of the present invention, the multiplicity of icons is presented to the subject via a computer connected to a computer network, and feedback from the subject is obtained via the computer network. In this embodiment, the feedback received is then analyzed by another computer connected to the computer network, located remotely from or in propinquity to the subject being tested.

FIG. 1 illustrates a preferred arrangement of icons useful in the present invention. It is appreciated that variations in the number, shape, arrangement and coloring of the icons may exist.

Icon 1 is a hollow gray circle. Icon 1 relates to a personality trait spectrum representing faith in the abstract. A subject's ranking of his reaction to icon 1 as +2 indicates that the subject has significant faith. A subject's ranking of his reaction to icon 1 as −2 indicates that the subject lacks faith. A subject's ranking of his reaction to icon 1 at a level between 2 and −2 indicates intermediate levels of faith, whereby higher numerals indicate greater abilities and lower numerals indicate lesser abilities of the subject within this personality trait spectrum.

Icon 1 also relates to a personality trait spectrum representing devotion and/or adherence to ideals. A subject's ranking of his reaction to icon 1 as +2 indicates that the subject has significant devotion to ideals, and tends to adhere to ideals. A subject's ranking of his reaction to icon 1 as −2 indicates that the subject encounters great difficulty in adhering to ideals, and lacks devotion to ideals. A subject's ranking of his reaction to icon 1 at a level between 2 and −2 indicates intermediate levels of devotion to ideals, whereby higher numerals indicate greater abilities and lower numerals indicate lesser abilities of the subject within this personality trait spectrum.

Icon 1 further relates to a personality trait spectrum representing simplicity in perception and in an approach to life. A subject's ranking of his reaction to icon 1 as +2 indicates that the subject has a simple perception of life and approaches issues in a simple manner. A subject's ranking of his reaction to icon 1 as −2 indicates that the subject encounters great difficulty in approaching life and issues simply, and rather has a complicated and complex approach to life. A subject's ranking of his reaction to icon 1 at a level between 2 and −2 indicates intermediate levels of simplicity of perception and approach to life, whereby higher numerals indicate greater abilities and lower numerals indicate lesser abilities of the subject within this personality trait spectrum.

Icon 1 additionally relates to a personality trait spectrum representing freedom and independence of choice. A subject's ranking of his reaction to icon 1 as +2 indicates that the subject makes his choices independently, and carries out his choices freely. A subject's ranking of his reaction to icon 1 as −2 indicates that the subject's decisions are easily influenced and/or are limited by external constraints, arguments and considerations. A subject's ranking of his reaction to icon 1 at a level between 2 and −2 indicates intermediate levels of freedom and independence of choice, whereby higher numerals indicate greater abilities and lower numerals indicate lesser abilities of the subject within this personality trait spectrum.

Icon 2 is formed of a pair of hollow, dark blue isosceles triangles arranged with their bases parallel to one another and their peaks adjacent one another. Icon 2 is symmetrical about a horizontal axis which extends parallel to the two bases and through the junction of the two peaks and about a vertical axis which extends through the junction of the two peaks.

Icon 2 relates to a personality trait spectrum representing satisfaction. A subject's ranking of his reaction to icon 2 as +2 indicates that the subject is generally satisfied and is not frustrated. A subject's ranking of his reaction to icon 2 as −2 indicates that the subject is often dissatisfied and frustrated. A subject's ranking of his reaction to icon 2 at a level between 2 and −2 indicates intermediate levels of satisfaction, whereby higher numerals indicate greater abilities and lower numerals indicate lesser abilities of the subject within this personality trait spectrum.

Icon 3 is a hollow red square, offset at a 45 degree angle from the horizontal. Icon 3 relates to a personality trait spectrum representing happiness. A subject's ranking of his reaction to icon 3 as +2 indicates that the subject is generally happy. A subject's ranking of his reaction to icon 3 as −2 indicates that the subject is generally unhappy and tends to be depressed. A subject's ranking of his reaction to icon 3 at a level between 2 and −2 indicates intermediate levels of happiness, whereby higher numerals indicate greater abilities and lower numerals indicate lesser abilities of the subject within this personality trait spectrum.

Icon 4 is a hollow blue circle, which is surrounded by a plurality of small blue squares forming a second circle.

Icon 4 relates to a personality trait spectrum representing self-fulfillment and finding one's mission in life. A subject's ranking of his reaction to icon 4 as +2 indicates that the subject is significantly self-fulfilled, and finds his mission in life. A subject's ranking of his reaction to icon 4 as −2 indicates that the subject encounters great difficulty in finding his mission in life, and is generally not self-fulfilled. A subject's ranking of his reaction to icon 4 at a level between 2 and −2 indicates intermediate levels of self-fulfillment, whereby higher numerals indicate greater abilities and lower numerals indicate lesser abilities of the subject within this personality trait spectrum.

Icon 5 is a hollow black square. Icon 5 relates to a personality trait spectrum representing the ability to identify and connect with things of importance or value, to define personal goals accordingly and to undertake the achievement of these goals. A subject's ranking of his reaction to icon 5 as +2 indicates that the subject is significantly capable of identifying and connecting with important or valuable things, defining personal goals accordingly and undertaking the achievement of these goals. A subject's ranking of his reaction to icon 5 as −2 indicates that the subject encounters great difficulty in identifying important or valuable things, in defining appropriate personal goals and/or in undertaking to achieve such goals. A subject's ranking of his reaction to icon 5 at a level between 2 and −2 indicates intermediate levels of ability to identify and connect with things of importance or value, to define personal goals accordingly, and to undertake the achievement of such goals, whereby higher numerals indicate greater abilities and lower numerals indicate lesser abilities of the subject within this personality trait spectrum.

Icon 6 is formed of a hollow yellow circle, in which is nested a red circle. The red circle is divided by yellow radii into twelve equal portions, and has a black dot as its center.

Icon 6 relates to a personality trait spectrum representing ambition and will power. A subject's ranking of his reaction to icon 6 as +2 indicates that the subject is significantly ambitious and has strong will power. A subject's ranking of his reaction to icon 6 as −2 indicates that the subject lacks ambition and generally has little or no will power. A subject's ranking of his reaction to icon 6 at a level between 2 and −2 indicates intermediate levels of ambition and will power, whereby higher numerals indicate greater abilities and lower numerals indicate lesser abilities of the subject within this personality trait spectrum.

Icon 7 is formed of a pair of isosceles triangles, each comprising nine smaller, hollow, isosceles triangles. Three of the nine smaller isosceles triangles, arranged along the bases of each of the larger triangles, are blue. Three of the isosceles triangles forming the upper boundaries of each of the larger triangles are dark blue and the internal isosceles triangles are purple. The two larger isosceles triangles are arranged with their bases parallel to one another and their peaks adjacent one another, such that icon 7 is symmetrical about a horizontal axis which extends parallel to the two bases and through the junction of the two peaks. Icon 7 is also symmetrical about a vertical axis extending through the junction of the two peaks.

Icon 7 relates to a personality trait spectrum representing intellectual originality and inventiveness and originality of abstract thinking. A subject's ranking of his reaction to icon 7 as +2 indicates that the subject has significant intellectual and inventive originality and creativity in the abstract and that when considering abstract problems, the subject is able to propose an original idea or solution which is often inventive. A subject's ranking of his reaction to icon 7 as −2 indicates that the subject encounters great difficulty in proposing original and creative ideas or solutions to abstract problems. A subject's ranking of his reaction to icon 7 at a level between 2 and −2 indicates intermediate levels of abstract originality and creativity of thinking, whereby higher numerals indicate greater abilities and lower numerals indicate lesser abilities of the subject within this personality trait spectrum.

Icon 8 is formed of a pair of isosceles triangles, each comprising nine smaller, hollow, isosceles triangles. Each of the nine smaller isosceles triangles is of a different color, such that the base of each of the larger triangles is defined by dark blue, gray and maroon triangles, which are connected by blue and red triangles. Adjacent the blue and red triangles, on a side which is distant from the base of the larger triangle, are purple, yellow and orange triangles. The apex of each of the larger triangles comprises a green isosceles triangle. The two isosceles triangles are arranged with their bases parallel to one another and their peaks adjacent one another, such that icon 8 is symmetrical about a horizontal axis which extends parallel to the two bases and through the junction of the two peaks.

Icon 8 relates to a personality trait spectrum representing intellectual originality and inventiveness and originality of practical thinking. A subject's ranking of his reaction to icon 8 as +2 indicates that the subject has significant intellectual and inventive originality and creativity in practical aspects, and that when considering practical problems, the subject is able to propose a practical and original idea or solution which is often inventive. A subject's ranking of his reaction to icon 8 as −2 indicates that the subject encounters great difficulty in proposing practical, original and creative ideas or solutions to practical problems. A subject's ranking of his reaction to icon 8 at a level between 2 and −2 indicates intermediate levels of practical originality and creativity of thinking, whereby higher numerals indicate greater abilities and lower numerals indicate lesser abilities of the subject within this personality trait spectrum.

Icons 7 and 8 together represent a personality trait spectrum representing intellectual associative and correlative thinking. A subject's ranking of his reactions to both icons 7 and 8 as +2 indicates that the subject has significant associative and correlative thinking with regards to both abstract and practical problems, and is highly capable of correlating and linking various related or associated topics. A subject's ranking of his reactions to both icons 7 and 8 as −2 indicates that the subject encounters great difficulty in linking connected or associated matters or problems, whether abstract or practical, and lacks the ability of associative and correlative thinking.

A subject's ranking of his reactions to icons 7 and 8 at levels between 2 and −2 indicates intermediate levels of associative and correlative thinking. Ranking of icon 7 by higher numerals indicates greater abilities and lower numerals indicate lesser abilities of the subject within a personality trait spectrum of associative and correlative thinking in the abstract. Ranking of icon 8 by higher numerals indicates greater abilities and lower numerals indicate lesser abilities of the subject within a personality trait spectrum of associative and correlative thinking related to practical matters. The subject's overall level of associative and correlative thinking is a combination of the subject's abilities within the personality trait spectra represented by icons 7 and 8.

Icons 7 and 8 together also represent a personality trait spectrum representing intellectual creativity and flexibility of thinking. A subject's ranking of his reactions to both icons 7 and 8 as +2 indicates that the subject has significant intellectual creativity and flexibility of thinking with regards to both abstract and practical problems, and is highly capable of rapidly adjusting to new ways of thinking and of understanding and accepting the opinions and thoughts of others, even when those opinions are different or opposed to those of the subject. A subject's ranking of his reactions to both icons 7 and 8 as −2 indicates that the subject encounters great difficulty in adjusting to new ways of thinking and in understanding and accepting the opinions and thoughts of others, and is generally not open to acceptance of other opinions.

A subject's ranking of his reactions to icons 7 and 8 at levels between 2 and −2 indicates intermediate intellectual creativity and flexibility of thinking. Ranking of icon 7 by higher numerals indicates greater abilities and lower numerals indicate lesser abilities of the subject within a personality trait spectrum of flexibility of thinking with respect to abstract ideas and topics. Ranking of icon 8 by higher numerals indicates greater abilities and lower numerals indicate lesser abilities of the subject within a personality trait spectrum of flexibility of thinking with respect to practical ideas and topics. The subject's overall levels of intellectual creativity and flexibility of thinking are a combination of the subject's abilities within the personality trait spectra represented by icons 7 and 8.

Icon 9 is formed of a plurality of nested hollow squares, offset at a 45 degree angle from the horizontal and sharing a common center, in the form of a non-hollow square. The outermost square is maroon, the next outermost square is dark red, and the middle square is red. The innermost square is light orange and the next innermost square is a darker orange. Each pair of adjacent squares is separated by a white square.

Icon 9 relates to a personality trait spectrum representing analytical skills when faced with abstract problems or ideas. A subject's ranking of his reaction to icon 9 as +2 indicates that the subject has significant analytical skills when faced with an abstract problem, is capable of analyzing the problem in a systematic and organized way down to the smallest detail, and feels satisfied and fulfilled by the analytical process. A subject's ranking of his reaction to icon 9 as −2 indicates that the subject encounters great difficulty in systematically analyzing abstract problems. A subject's ranking of his reaction to icon 9 at a level between 2 and −2 indicates intermediate levels of analytical skills in the abstract, whereby higher numerals indicate greater abilities and lower numerals indicate lesser abilities of the subject within this personality trait spectrum.

Icon 10 is formed of a plurality of nested hollow squares, offset at a 45 degree angle from the horizontal and sharing a common center in the form of a non-hollow square. Each of the squares is of a different color, such that the outermost square is blue, the next outermost square is red, and the next outermost square after that is yellow. The innermost square is brown, the next innermost square is green, and the next innermost square is orange. The middle square is purple. Each pair of adjacent squares is separated by a white square.

Icon 10 relates to a personality trait spectrum representing analytical skills when faced with practical problems or ideas. A subject's ranking of his reaction to icon 10 as +2 indicates that the subject has significant analytical skills when faced with a practical problem, is capable of analyzing the problem in a systematic and organized way down to the smallest detail, and feels satisfied and fulfilled by the analytical process. A subject's ranking of his reaction to icon 10 as −2 indicates that the subject encounters great difficulty in systematically analyzing practical problems. A subject's ranking of his reaction to icon 10 at a level between 2 and −2 indicates intermediate levels of practical analytical skills, whereby higher numerals indicate greater abilities and lower numerals indicate lesser abilities of the subject within this personality trait spectrum.

Icons 9 and 10 together represent a personality trait spectrum representing intellectual abilities of introspection. A subject's ranking of his reactions to both icons 9 and 10 as +2 indicates that the subject has significant introspective abilities with regards to both abstract and practical topics, and is highly capable of analyzing and profoundly understanding various topics. A subject's ranking of his reactions to both icons 9 and 10 as −2 indicates that the subject encounters great difficulty in analyzing and profoundly understanding matters or problems, whether abstract or practical, and lacks introspective abilities.

A subject's ranking of his reactions to icons 9 and 10 at levels between 2 and −2 indicates intermediate levels of introspective and analytical abilities. Ranking of icon 9 by higher numerals indicates greater abilities and lower numerals indicate lesser abilities of the subject within a personality trait spectrum of introspective and analytical skills in the abstract. Ranking of icon 10 by higher numerals indicates greater abilities and lower numerals indicate lesser abilities of the subject within a personality trait spectrum of introspective and analytical skills related to practical matters. The subject's overall level of introspective and analytical abilities is a combination of the subject's abilities within the personality trait spectra represented by icons 9 and 10.

Icon 11 is a square formed of sixteen smaller, hollow squares. Twelve of the sixteen smaller squares, arranged along the edges of the square, are black, and the remaining smaller squares, disposed in the center of the square, are yellow.

Icon 12 is a square formed of sixteen smaller, hollow squares. Twelve of the sixteen smaller squares, arranged along the edges of the square, are in various shades of gray, such that the smaller squares defining the top right and bottom left corners of the square are dark gray, the squares defining the bottom right and top left corners are light gray, and the intermediate squares are of intermediate shades of gray. Of the remaining smaller squares, disposed in the center of the square, the pair of squares located along the diagonal extending between the two dark gray squares are red, and the pair of squares located along the diagonal extending between the two light gray squares are blue. The square is symmetrical about each of its diagonals.

Icons 8, 10 and 12 together represent a personality trait spectrum representing intuitive decisiveness, rational decisiveness and the ability to actually carry out the decision, regardless of its origin. A subject's ranking of his reactions to all of icons 8, 10 and 12 as +2 indicates that the subject is significantly decisive, whether when making decisions intuitively or by using logical reasons for his decision, and is generally capable of carrying out the decisions, regardless of their origin. A subject's ranking of his reactions to all of icons 8, 10 and 12 as −2 indicates that the subject encounters great difficulty in making decisions and in providing intuitive and/or rational reasons for the decisions made, and is not capable of carrying out the decisions made.

A subject's ranking of his reactions to icons 8, 10 and 12 at levels between 2 and −2 indicates intermediate levels of intuitive and logical decisiveness. Ranking of icon 8 by higher numerals indicates greater abilities and lower numerals indicate lesser abilities of the subject within a personality trait spectrum of intuitive decisiveness and the ability to provide intuitive arguments to support the decision made. Ranking of icon 10 by higher numerals indicates greater abilities and lower numerals indicate lesser abilities of the subject within a personality trait spectrum of logical and rational decisiveness and the ability to provide rational arguments to support the decision made. Ranking of icon 12 by higher numerals indicates greater abilities and lower numerals indicate lesser abilities of the subject within a personality trait spectrum of the ability to carry out the decisions made, regardless of their origin. The subject's overall levels of intuitive and rational decisiveness and abilities of carrying out decisions are a combination of the subject's abilities within the three personality trait spectra represented by icons 8, 10 and 12.

Icons 11 and 12 together represent a personality trait spectrum representing the cognitive acknowledgment and acceptance of moral values and the ability to live by such moral values. A subject's ranking of his reactions to both icons 11 and 12 as +2 indicates that the subject clearly acknowledges and accepts the importance of moral values, and is significantly capable of living by such moral values and of directing his lifestyle to conform to such moral values. A subject's ranking of his reactions to both icons 11 and 12 as −2 indicates that the subject encounters great difficulty in acknowledging and accepting the importance of moral values and finds it difficult to lead his life in accordance with such moral values or to change his lifestyle to conform to them.

A subject's ranking of his reactions to icons 11 and 12 at levels between 2 and −2 indicates intermediate levels of cognitive acknowledgment and acceptance of moral values and of ability to live by such moral values. Ranking of icon 11 by higher numerals indicates greater abilities and lower numerals indicate lesser abilities of the subject within a personality trait spectrum of cognitive acknowledgment and acceptance of moral values and of their importance. Ranking of icon 12 by higher numerals indicates greater abilities and lower numerals indicate lesser abilities of the subject within a personality trait spectrum of the ability to live by moral values and to change one's lifestyle to conform to such moral values. The subject's overall levels of cognitive acknowledgement and acceptance of moral values and of ability to live by such moral values are a combination of the subject's abilities within the personality trait spectra represented by icons 11 and 12.

Icon 13 is formed of a plurality of nested hollow squares, offset at a 45 degree angle from the horizontal and sharing a common center in the form of a non-hollow square. The outermost square is brown, the next outermost square is maroon, and the middle square is red. The innermost square is dark blue, and the next innermost square is gray. Each pair of adjacent squares is separated by a white square.

Icon 13 relates to a personality trait spectrum representing wealth of intellectual vocabulary and the ability to use such a vocabulary at ease. A subject's ranking of his reaction to icon 13 as +2 indicates that the subject has a rich intellectual vocabulary, and has significant abilities of using this vocabulary in the appropriate manner and at suitable times. A subject's ranking of his reaction to icon 13 as −2 indicates that the subject has a poor intellectual vocabulary and encounters great difficulty in selecting the appropriate words at suitable times. A subject's ranking of his reaction to icon 13 at a level between 2 and −2 indicates intermediate levels of wealth of vocabulary and ability of use thereof, whereby higher numerals indicate greater abilities and lower numerals indicate lesser abilities of the subject within this personality trait spectrum.

Icon 14 is formed of a plurality of nested squares, offset at a 45 degree angle from the horizontal and sharing a common center. The outermost square is navy blue and the innermost square is pale blue. Each intermediate square is in an intermediate shade of blue, such that outer squares are in darker shades of blue and inner squares are in lighter shades of blue.

Icon 14 relates to a personality trait spectrum representing love and affection. A subject's ranking of his reaction to icon 14 as +2 indicates that the subject has significant abilities of showing his love and affection. A subject's ranking of his reaction to icon 14 as −2 indicates that the subject has great difficulty in showing his love and affection. A subject's ranking of his reaction to icon 14 at a level between 2 and −2 indicates intermediate levels of love and affection, whereby higher numerals indicate greater abilities and lower numerals indicate lesser abilities of the subject within this personality trait spectrum.

Icon 14 also relates to a personality trait spectrum representing kindness and good-heartedness. A subject's ranking of his reaction to icon 14 as +2 indicates that the subject is significantly kind and good-hearted. A subject's ranking of his reaction to icon 14 as −2 indicates that the subject lacks or has little kindness and good-heartedness. A subject's ranking of his reaction to icon 14 at a level between 2 and −2 indicates intermediate levels of kindness and good-heartedness, whereby higher numerals indicate greater abilities and lower numerals indicate lesser abilities of the subject within this personality trait spectrum.

Icon 15 is a square which is formed of sixteen smaller squares. The sixteen smaller squares are divided into four groups of squares, each including four squares of the same color. A first group includes dark red colored squares, a second group includes red squares, a third group includes dark pink squares and a fourth group includes light pink squares. Each row and each column of the square includes a single representative from each of the groups of squares, and therefore includes one each of dark red, red, dark pink and light pink squares.

Icon 15 relates to a personality trait spectrum representing emotional self-control. A subject's ranking of his reaction to icon 15 as +2 indicates that the subject has significant abilities of emotional self-control. A subject's ranking of his reaction to icon 15 as −2 indicates that the subject lacks emotional self-control. A subject's ranking of his reaction to icon 15 at a level between 2 and −2 indicates intermediate levels of emotional self-control, whereby higher numerals indicate greater abilities and lower numerals indicate lesser abilities of the subject within this personality trait spectrum.

Icon 15 also relates to a personality trait spectrum representing constructive rewarding and/or punishing in a proportionate manner. A subject's ranking of his reaction to icon 15 as +2 indicates that the subject has significant abilities of constructive rewarding and punishing in proper measures. A subject's ranking of his reaction to icon 15 as −2 indicates that the subject gives rewards and/or punishes without proportions. A subject's ranking of his reaction to icon 15 at a level between 2 and −2 indicates intermediate levels of rewarding and/or punishing in a proportionate manner, whereby higher numerals indicate greater abilities and lower numerals indicate lesser abilities of the subject within this personality trait spectrum.

Icon 15 further relates to a personality trait spectrum representing courage and bravery. A subject's ranking of his reaction to icon 15 as +2 indicates that the subject has significant courage and bravery. A subject's ranking of his reaction to icon 15 as −2 indicates that the subject lacks courage and bravery. A subject's ranking of his reaction to icon 15 at a level between 2 and −2 indicates intermediate levels of courage and bravery, whereby higher numerals indicate greater abilities and lower numerals indicate lesser abilities of the subject within this personality trait spectrum.

Icon 16 is formed of a pair of isosceles triangles, each comprising nine smaller, isosceles triangles. The nine smaller isosceles triangles are divided into three groups, each including three isosceles triangles in the same color. The base of each of the larger triangles is defined by a first group of smaller isosceles triangles which are a light shade of yellow. The upper boundaries of each of the larger triangles are defined by a second group of smaller isosceles triangles which are an intermediate shade of yellow. The internal smaller isosceles triangles, which form a third group, are a dark shade of yellow. The two isosceles triangles are arranged with their bases parallel to one another and their peaks adjacent one another, such that icon 16 is symmetrical about a horizontal axis which extends parallel to the two bases and through the junction of the two peaks. Icon 16 is also symmetrical about a vertical axis extending through the junction of the two peaks.

Icon 16 relates to a personality trait spectrum representing compassion, mercy and empathy. A subject's ranking of his reaction to icon 16 as +2 indicates that the subject has significant abilities of showing compassion, mercy and empathy. A subject's ranking of his reaction to icon 16 as −2 indicates that the subject lacks or has little compassion, mercy and empathy. A subject's ranking of his reaction to icon 16 at a level between 2 and −2 indicates intermediate levels of compassion, mercy and empathy, whereby higher numerals indicate greater abilities and lower numerals indicate lesser abilities of the subject within this personality trait spectrum.

Icon 17 is a square, which is formed of sixteen smaller squares. The sixteen smaller squares are divided into four groups of squares, each including four squares of the same color. The four groups of squares are all different shades of purple ranging from a dark purple to a light purple. Each row and each column of the square includes a single representative from each of the groups of squares, and therefore includes one of each shade of purple squares.

Icon 17 relates to a personality trait spectrum representing confidence. A subject's ranking of his reaction to icon 17 as +2 indicates that the subject has significant confidence. A subject's ranking of his reaction to icon 17 as −2 indicates that the subject lacks or has little confidence. A subject's ranking of his reaction to icon 17 at a level between 2 and −2 indicates intermediate levels of confidence, whereby higher numerals indicate greater abilities and lower numerals indicate lesser abilities of the subject within this personality trait spectrum.

Icon 18 is formed of a pair of isosceles triangles, each comprising nine smaller, isosceles triangles. The nine smaller isosceles triangles are divided into three groups, each including three isosceles triangles in the same color. The base of each of the larger triangles is defined by a first group of smaller isosceles triangles which are a light shade of orange. The upper boundaries of each of the larger triangles are defined by a second group of smaller isosceles triangles which are a dark shade of orange. The internal smaller isosceles triangles, which form a third group, are a dark shade of orange. The two isosceles triangles are arranged with their bases parallel to one another and their peaks adjacent one another, such that icon 18 is symmetrical about a horizontal axis which extends parallel to the two bases and through the junction of the two peaks. Icon 18 is also symmetrical about a vertical axis extending through the junction of the two peaks.

Icon 18 relates to a personality trait spectrum representing internal peace, quiet and calmness and the ability to maintain a course of action even under pressure or stress. A subject's ranking of his reaction to icon 18 as +2 indicates that the subject has significant internal peace, quiet and calmness, and is highly able to maintain his course of action even under pressure or stress. A subject's ranking of his reaction to icon 18 as −2 indicates that the subject lacks or has little internal peace, quiet and calmness and is easily set off his course of action, specifically when under pressure or stress. A subject's ranking of his reaction to icon 18 at a level between 2 and −2 indicates intermediate levels of internal peace, quiet and calmness and of the ability to maintain a course, whereby higher numerals indicate greater abilities and lower numerals indicate lesser abilities of the subject within this personality trait spectrum.

Icon 18 also relates to a personality trait spectrum representing the abilities of thanking, appreciating, admitting, acknowledging and giving credit. A subject's ranking of his reaction to icon 18 as +2 indicates that the subject has significant abilities of thanking, appreciating, admitting, acknowledging and giving credit. A subject's ranking of his reaction to icon 18 as −2 indicates that the subject encounters great difficulty in thanking, appreciating, admitting, acknowledging and giving credit. A subject's ranking of his reaction to icon 18 at a level between 2 and −2 indicates intermediate levels of abilities of thanking, appreciating, admitting, acknowledging and giving credit, whereby higher numerals indicate greater abilities and lower numerals indicate lesser abilities of the subject within this personality trait spectrum.

Icon 18 further relates to a personality trait spectrum representing dependence and addiction. A subject's ranking of his reaction to icon 18 as +2 indicates that the subject is highly unlikely to become addicted or dependent and can easily release himself from addiction. A subject's ranking of his reaction to icon 18 as −2 indicates that the subject is highly dependent, likely to become addicted and encounters great difficulty in releasing himself from addiction and/or dependence. A subject's ranking of his reaction to icon 18 at a level between 2 and −2 indicates intermediate levels of dependence and addiction, whereby higher numerals indicate greater abilities and lower numerals indicate lesser abilities of the subject within this personality trait spectrum. Icon 19 is formed of a plurality of nested squares, offset at a 45 degree angle from the horizontal and sharing a common center. The outermost square is dark green and the innermost square is pale green. Each intermediate square is in an intermediate shade of green, such that outer squares are in darker shades of green and inner squares are in lighter shades of green.

Icon 19 relates to a personality trait spectrum representing personal honesty, and integrity. A subject's ranking of his reaction to icon 19 as +2 indicates that the subject has significant abilities of personal honesty and integrity. A subject's ranking of his reaction to icon 19 as −2 indicates that the subject lacks or has little personal honesty and integrity. A subject's ranking of his reaction to icon 19 at a level between 2 and −2 indicates intermediate levels of personal honesty and integrity, whereby higher numerals indicate greater abilities and lower numerals indicate lesser abilities of the subject within this personality trait spectrum.

Icon 19 also relates to a personality trait spectrum representing the abilities of forming stable and permanent personal relationships having peace and harmony. A subject's ranking of his reaction to icon 19 as +2 indicates that the subject has significant abilities of forming stable and permanent personal relationships having peace and harmony. A subject's ranking of his reaction to icon 19 as −2 indicates that the subject encounters great difficulty in forming stable and permanent personal relationships having peace and harmony. A subject's ranking of his reaction to icon 19 at a level between 2 and −2 indicates intermediate levels of the ability to form stable and permanent personal relationships, whereby higher numerals indicate greater abilities and lower numerals indicate lesser abilities of the subject within this personality trait spectrum.

Icons 17, 18 and 19 together represent a personality trait spectrum representing habits, including the ability to define, be attracted to and identify good and/or proper habits for oneself, flexibility and openness toward change of habits and stability in preserving and permanently maintaining habits. A subject's ranking of his reactions to all of icons 17, 18 and 19 as +2 indicates that the subject is significantly able to define, be attracted to and identify good and/or proper habits for himself, is significantly flexible and open toward change of habits and can easily adopt new habits and is highly capable of preserving and permanently maintaining habits. A subject's ranking of his reactions to all of icons 17, 18 and 19 as −2 indicates that the subject encounters great difficulty in defining, being attracted to and identifying good and/or proper habits for himself, is not accepting and is not open toward change of habits and finds it difficult to adopt new habits and is incapable of preserving and permanently maintaining habits.

A subject's ranking of his reactions to icons 17, 18 and 19 at levels between 2 and −2 indicates intermediate levels of flexibility and openness toward change of habits, stability in preserving and permanently maintaining habits and the ability to define, be attracted to and identify good and/or proper habits for oneself. Ranking of icon 17 by higher numerals indicates greater abilities and lower numerals indicate lesser abilities of the subject within a personality trait spectrum of the ability to define, be attracted to and identify good and/or proper habits for oneself. Ranking of icon 18 by higher numerals indicates greater abilities and lower numerals indicate lesser abilities of the subject within a personality trait spectrum of flexibility and openness to change of habits and ease of adoption of new habits. Ranking of icon 19 by higher numerals indicates greater abilities and lower numerals indicate lesser abilities of the subject within a personality trait spectrum of the ability to preserve and permanently maintain habits. The subject's overall levels of flexibility and openness toward change of habits, stability in preserving and permanently maintaining habits and the ability to define, be attracted to and identify good and/or proper habits for oneself are a combination of the subject's abilities within the three personality trait spectra represented by icons 17, 18 and 19.

Icon 20 is formed of a pair of isosceles triangles, each comprising nine smaller isosceles triangles. Each of the nine smaller isosceles triangles is of a different color, such that the base of each of the triangles is defined by dark blue, gray and maroon triangles, which are connected by blue and red triangles. Adjacent the blue and red triangles, on a side which is distant from the base of the larger triangle, are purple and orange triangles which are connected by a yellow triangle. The apex of each of the larger triangles comprises a green isosceles triangle. The two larger isosceles triangles are arranged such that their bases are parallel to one another, and their peaks are adjacent one another, such that icon 20 is symmetrical about a horizontal axis which extends parallel to the two bases and through the junction of the two peaks.

Icon 20 relates to a personality trait spectrum representing natural emotional openness. A subject's ranking of his reaction to icon 20 as +2 indicates that the subject has significant natural emotional openness. A subject's ranking of his reaction to icon 20 as −2 indicates that the subject lacks or has little natural emotional openness. A subject's ranking of his reaction to icon 20 at a level between 2 and −2 indicates intermediate levels of natural emotional openness, whereby higher numerals indicate greater abilities and lower numerals indicate lesser abilities of the subject within this personality trait spectrum.

Icon 21 is formed of a plurality of nested circles, which share a common center. Each of the circles is of a different color, such that the outermost circle is blue, the next outermost circle is red, and the next circle square after that is yellow. The innermost circle is brown, the next innermost circle is green, and the next innermost circle is orange. The middle circle is purple.

Icon 21 relates to a personality trait spectrum representing expressiveness and wealth of vocabulary of words available to speech. A subject's ranking of his reaction to icon 21 as +2 indicates that the subject is significantly able to express himself and has rich vocabulary of words available to speech. A subject's ranking of his reaction to icon 21 as −2 indicates that the subject encounters great difficulty in expressing himself and has a poor vocabulary of words available to speech. A subject's ranking of his reaction to icon 21 at a level between 2 and −2 indicates intermediate levels of expressiveness and wealth of vocabulary available to speech, whereby higher numerals indicate greater abilities and lower numerals indicate lesser abilities of the subject within this personality trait spectrum.

Icon 21 also relates to a personality trait spectrum representing orientation, direction, motivation and drive for actions, including orientation and motivations for a real, needy, justified purpose as opposed to motivation for actions carried out purely for personal benefits and gains. A subject's ranking of his reaction to icon 21 as +2 indicates that the subject is significantly driven and motivated to action, and specifically to act in real, justified and needy purposes and is less motivated for actions carried out purely for personal benefits and gains. A subject's ranking of his reaction to icon 21 as −2 indicates that the subject encounters great difficulty in being driven or motivated to act for needy and justified purposes, and is more driven and motivated to actions which provide or are purely for personal benefits and gains. A subject's ranking of his reaction to icon 21 at a level between 2 and −2 indicates intermediate levels of orientation, direction, motivation and drive for actions, whereby higher numerals indicate greater abilities and lower numerals indicate lesser abilities of the subject within this personality trait spectrum.

Icons 20 and 21 represent a personality trait spectrum representing proper orientation, conduct and drive in marital connections and relationships, where icon 20 relates to this trait spectrum in women and icon 21 relates to this trait spectrum in men. A subject's ranking of his reactions to icons 20 or 21 as +2 indicates that the subject has significant abilities of proper orientation, conduct and drive in marital connections and relationships. A subject's ranking of his reactions to icons 20 or 21 as −2 indicates that the subject encounters great difficulty in proper orientation, conduct and drive in marital connections and relationships. A subject's ranking of his reaction to icons 20 or 21 at a level between 2 and −2 indicates intermediate levels of proper orientation, conduct and drive in marital connections and relationships, whereby higher numerals indicate greater abilities and lower numerals indicate lesser abilities of the subject within this personality trait spectrum.

Icon 22 is formed of a plurality of nested circles, which share a common center. The outermost circle is dark brown and the innermost circle is light brown. Each intermediate circle is in an intermediate shade of brown, such that outer circles are in darker shades of brown and inner circles are in lighter shades of brown.

Icon 22 relates to a personality trait spectrum representing humility and obedience. A subject's ranking of his reaction to icon 22 as +2 indicates that the subject is significantly humble and obedient. A subject's ranking of his reaction to icon 22 as −2 indicates that the subject lacks or has little humility and obedience. A subject's ranking of his reaction to icon 21 at a level between 2 and −2 indicates intermediate levels of humility and obedience, whereby higher numerals indicate greater abilities and lower numerals indicate lesser abilities of the subject within this personality trait spectrum.

Icon 23 is formed of a plurality of nested hollow circles, which share a common center in the form of a non-hollow circle. The outermost circle is brown, the next circle is maroon, and the middle circle is red. The innermost circle is dark blue, and the next innermost circle is gray. Each pair of adjacent circles is separated by a white circle.

Icon 23 relates to a personality trait spectrum representing focus and control of thought. A subject's ranking of his reaction to icon 23 as +2 indicates that the subject has significant focus of thought, and that his thoughts do not wander to unimportant or irrelevant topics. A subject's ranking of his reaction to icon 23 as −2 indicates that the subject encounters great difficulty focusing his thoughts, and that his thoughts often wander to irrelevant or unimportant topics. A subject's ranking of his reaction to icon 23 at a level between 2 and −2 indicates intermediate levels focus of thought, whereby higher numerals indicate greater abilities and lower numerals indicate lesser abilities of the subject within this personality trait spectrum.

Icon 24 is formed of a plurality of nested hollow circles, which share a common center in the form of a non-hollow circle. Each of the circles is of a different color, such that the outermost circle is blue, the next outermost circle is red, and the next outermost circle after that is yellow. The innermost circle is brown, the next innermost circle is green, and the next innermost circle is orange. The middle circle is purple. Each pair of adjacent circles is separated by a white circle.

Icon 24 relates to a personality trait spectrum representing behavior of speech, including necessary and required words that express the idea one wishes to convey as opposed to unnecessary words that may confuse a listener and are not required in order to express the idea being conveyed. A subject's ranking of his reaction to icon 24 as +2 indicates that the subject usually uses only necessary words in verbal expression. A subject's ranking of his reaction to icon 24 as −2 indicates that the subject uses unnecessary words, that may confuse a listener, in expressing ideas. A subject's ranking of his reaction to icon 24 at a level between 2 and −2 indicates intermediate levels of behavior of speech, whereby higher numerals indicate greater abilities and lower numerals indicate lesser abilities of the subject within this personality trait spectrum.

Icon 25 is formed of a plurality of nested hollow circles, which share a common center in the form of a non-hollow circle. The outermost circle is dark brown and the innermost circle is light brown. Each intermediate circle is in an intermediate shade of brown, such that outer circles are in darker shades of brown and inner circles are in lighter shades of brown. Each pair of adjacent circles is separated by a white circle.

Icon 25 relates to a personality trait spectrum representing behavior of actions, including focused and efficient actions as opposed to performing extra, unnecessary and wasted actions and motions. A subject's ranking of his reaction to icon 25 as +2 indicates that the subject's actions are usually focused and efficient, and that the subject generally does not perform unnecessary or wasted motions or actions. A subject's ranking of his reaction to icon 25 as −2 indicates that the subject lacks the ability to act efficiently and in a focused manner, and performs many extra, unnecessary and wasted actions and motions. A subject's ranking of his reaction to icon 25 at a level between 2 and −2 indicates intermediate levels of efficiency of actions.

Icon 26 is formed of a pair of isosceles triangles, one being purple and the other being yellow. The two triangles are arranged along a common base, and together define a square offset at a 45 degree angle from the horizontal. The square defined by the two triangles is symmetrical about a vertical axis extending between the peaks of the two isosceles triangles. In the sense of FIG. 1, the purple triangle is located vertically above the yellow triangle.

Icon 26 relates to a personality trait spectrum representing the sense and instinct of conversation, including the ability to say the right things at the right times in the appropriate tone, the ability to hold conversations having real content and not holding conversations unnecessarily or for no reason. A subject's ranking of his reaction to icon 26 as +2 indicates that the subject has a significantly good sense and instinct of conversation, is generally able to say the right things at the right times in an appropriate tone, holds conversations having real contents and generally does not hold unnecessary conversations or ones having no real meaning. A subject's ranking of his reaction to icon 26 as −2 indicates that the subject lacks sense and instinct of conversation, usually is not able to say the right things at the right times, uses an inappropriate tone, and holds unnecessary and/or meaningless conversations. A subject's ranking of his reaction to icon 26 at a level between 2 and −2 indicates intermediate levels of sense and instinct of conversation, whereby higher numerals indicate greater abilities and lower numerals indicate lesser abilities of the subject within this personality trait spectrum.

Icon 27 is formed of a pair of isosceles triangles, one being red and the other being yellow. The two triangles are arranged along a common base, and together define a square offset at a 45 degree angle from the horizontal. The square defined by the two triangles is symmetrical about a horizontal axis extending between the peaks of the two isosceles triangles. In the sense of FIG. 1, the red triangle is located to the left of the yellow triangle.

Icon 27 relates to a personality trait spectrum representing the sense and instinct of contemplation, including the ability to visualize in one's mind real pictures of objects prior to thinking of those objects in letters and words, and the ability to use such visualizations to make or draw connections or connotations. A subject's ranking of his reaction to icon 27 as +2 indicates that the subject has a significantly good sense and instinct of contemplation, is generally able to visualize in his mind real pictures of objects even before thinking of those objects in letters and words, and is able to use these pictures visualized in his mind to make connections or connotations. A subject's ranking of his reaction to icon 27 as −2 indicates that the subject lacks sense and instinct of contemplation, usually is unable to visualize objects prior to thinking about them in letters and words, and cannot use visual pictures of objects to make connections or connotations. A subject's ranking of his reaction to icon 26 at a level between 2 and −2 indicates intermediate levels of sense and instinct of contemplation, whereby higher numerals indicate greater abilities and lower numerals indicate lesser abilities of the subject within this personality trait spectrum.

Icon 28 is formed of a pair of isosceles triangles, one being orange and the other being yellow. The two isosceles triangles are arranged with their bases parallel to one another and their peaks adjacent one another, such that a horizontal axis extends parallel to the two bases and through the junction of the two peaks. Icon 28 is symmetrical about a vertical axis, which is perpendicular to the two bases and extends through the junction of the two peaks. In the sense of FIG. 1, the yellow triangle is located above the orange triangle.

Icon 28 relates to a personality trait spectrum representing the sense and instinct of motion, including the ability to accelerate, to make progress and to grow at an accelerated pace. A subject's ranking of his reaction to icon 28 as +2 indicates that the subject has a significantly good sense and instinct of motion and is generally able to accelerate, to make progress and to grow at an accelerated pace. A subject's ranking of his reaction to icon 28 as −2 indicates that the subject lacks sense and instinct of motion and lacks the ability to accelerate, to make progress and to grow at an accelerated pace. A subject's ranking of his reaction to icon 28 at a level between 2 and −2 indicates intermediate levels of sense and instinct of motion, whereby higher numerals indicate greater abilities and lower numerals indicate lesser abilities of the subject within this personality trait spectrum.

Icon 29 is formed of a pair of isosceles triangles, one being purple and the other being blue. The two isosceles triangles are arranged with their bases parallel to one another and their peaks adjacent one another, such that a horizontal axis extends parallel to the two bases and through the junction of the two peaks. Icon 29 is symmetrical about a vertical axis, which is perpendicular to the two bases and extends through the junction of the two peaks. In the sense of FIG. 1, the purple triangle is located above the blue triangle.

Icon 29 relates to a personality trait spectrum representing the sense and instinct of realistic vision and sight, including the ability to realize what is really going on, even behind the scenes, to know what stands behind the external and often shallow and superficial appearance of things, events and occurrences, and to see things in true depth and meaning. A subject's ranking of his reaction to icon 29 as +2 indicates that the subject has a significantly good sense and instinct of realistic vision and sight and is generally able to understand and see the true nature of people, things and events, and to see beyond the appearance thereof. A subject's ranking of his reaction to icon 29 as −2 indicates that the subject lacks sense and instinct of realistic vision and sight and is unable to realize what is really going on behind the scenes and does not see beyond the external, superficial appearance of things, people, events and occurrences. A subject's ranking of his reaction to icon 29 at a level between 2 and −2 indicates intermediate levels of sense and instinct of realistic vision and sight, whereby higher numerals indicate greater abilities and lower numerals indicate lesser abilities of the subject within this personality trait spectrum.

Icon 30 is formed of a pair of rectangles, one being yellow and the other being blue. The two rectangles are arranged along a common edge, and together define a square. The square defined by the two rectangles is symmetrical about a horizontal axis extending through the center of the square. In the sense of FIG. 1, the yellow rectangle is located to the left of the blue rectangle.

Icon 30 relates to a personality trait spectrum representing the sense and instinct of optimism, including the ability to see the good and positive sides in everything that happens. A subject's ranking of his reaction to icon 30 as +2 indicates that the subject is significantly optimistic, and is generally capable of seeing the good and positive sides of everything that happens. A subject's ranking of his reaction to icon 30 as −2 indicates that the subject encounters great difficulty in being optimistic, and does not see the good or positive sides of things that happen. A subject's ranking of his reaction to icon 30 at a level between 2 and −2 indicates intermediate levels of optimism, whereby higher numerals indicate greater abilities and lower numerals indicate lesser abilities of the subject within this personality trait spectrum.

Icon 31 is formed of a pair of rectangles, one being blue and the other being orange. The two rectangles are arranged along a common edge, and together define a square. The square defined by the two rectangles is symmetrical about a vertical axis extending through the center of the square. In the sense of FIG. 1, the blue rectangle is located above the orange rectangle.

Icon 31 relates to a personality trait spectrum representing the ability of correction and solving of problems, including the ability to truly fix and correct every problem from its main core point, to be able to identify the source of each problem in order to fully correct and solve it. A subject's ranking of his reaction to icon 31 as +2 indicates that the subject has significant abilities of correction and solving of problems, and is generally capable identifying the source and core of a problem or mistake in order to fully correct every aspect of it. A subject's ranking of his reaction to icon 31 as −2 indicates that the subject encounters great difficulty in fully solving or correcting problems and in identifying the source or core of such problems. A subject's ranking of his reaction to icon 31 at a level between 2 and −2 indicates intermediate levels of ability of corrections and solving of problems, whereby higher numerals indicate greater abilities and lower numerals indicate lesser abilities of the subject within this personality trait spectrum.

Icon 32 is formed of a pair of isosceles triangles, one being purple and the other being green. The two isosceles triangles are arranged with their bases parallel to one another and their peaks adjacent one another, such that a horizontal axis extends parallel to the two bases and through the junction of the two peaks. Icon 32 is symmetrical about a vertical axis, which is perpendicular to the two bases and extends through the junction of the two peaks. In the sense of FIG. 1, the purple triangle is located above the green triangle.

Icon 32 relates to a personality trait spectrum representing the ability to push things forward, including the ability to push potential concepts into complete and fast materialization by identifying the precise balance between all the participating factors and parameters. A subject's ranking of his reaction to icon 32 as +2 indicates that the subject has significant abilities of pushing things forward and of materializing potential concepts by identifying the precise balance between the factors and parameters participating in these concepts. A subject's ranking of his reaction to icon 32 as −2 indicates that the subject encounters great difficulty in pushing things forward and in materializing potential concepts. A subject's ranking of his reaction to icon 31 at a level between 2 and −2 indicates intermediate levels of the ability to push things forward, whereby higher numerals indicate greater abilities and lower numerals indicate lesser abilities of the subject within this personality trait spectrum.

Icon 33 is formed of a pair of isosceles triangles, one being blue and the other being green. The two triangles are arranged along a common base, and together define a square offset at a 45 degree angle from the horizontal. The square defined by the two triangles is symmetrical about a horizontal axis extending between the peaks of the two isosceles triangles. In the sense of FIG. 1, the blue triangle is located to the left of the green triangle.

Icon 33 relates to a personality trait spectrum representing the sense and instinct of timing, including the ability to wait patiently and with restraint as long as necessary and to act out of total readiness and the ability to use the element of surprise in the right manner and context. A subject's ranking of his reaction to icon 33 as +2 indicates that the subject has a significant sense and instinct of timing, is able to wait patiently and with restraint as long as necessary and to act out of total readiness at the right time and is able to use the element of surprise in the right manner and context. A subject's ranking of his reaction to icon 33 as −2 indicates that the subject lacks a sense and instinct of timing, is unable to wait patiently, does not act only when totally ready and lacks the ability to use the element of surprise in the right manner or context. A subject's ranking of his reaction to icon 33 at a level between 2 and −2 indicates intermediate levels of sense and instinct of timing, whereby higher numerals indicate greater abilities and lower numerals indicate lesser abilities of the subject within this personality trait spectrum.

Icon 34 is formed of a pair of rectangles, one being green and the other being orange. The two rectangles are arranged along a common edge, and together define a square. The square defined by the two rectangles is symmetrical about a vertical axis extending through the center of the square. In the sense of FIG. 1, the green rectangle is located above the orange rectangle.

Icon 34 relates to a personality trait spectrum representing the ability to influence others, including the ability to convince others and bring them to your own standing out of compassion, understanding and consideration of their current position while being consistent and persistent. A subject's ranking of his reaction to icon 34 as +2 indicates that the subject has a significant ability to influence others, and does it with compassion, understanding and consideration of the others' current positions. A subject's ranking of his reaction to icon 34 as −2 indicates that the subject encounters great difficulty in convincing others out of compassion, understanding and consideration of their current position while being consistent and persistent. A subject's ranking of his reaction to icon 34 at a level between 2 and −2 indicates intermediate levels of the ability to convince others, whereby higher numerals indicate greater abilities and lower numerals indicate lesser abilities of the subject within this personality trait spectrum.

Icon 35 is formed of a pair of rectangles, one being purple and the other being red. The two rectangles are arranged along a common edge, and together define a square. The square defined by the two rectangles is symmetrical about a vertical axis extending through the center of the square. In the sense of FIG. 1, the purple rectangle is located above the red rectangle.

Icon 35 relates to a personality trait spectrum representing the ability to identify negative points in one's surroundings and to define these negative points as challenges to be tackled and wrestled with. A subject's ranking of his reaction to icon 35 as +2 indicates that the subject has a significant ability to identify negative points in his surroundings and to define these negative points as challenges to be tackled and wrestled with. A subject's ranking of his reaction to icon 35 as −2 indicates that the subject encounters great difficulty in identifying negative points in his surroundings and in defining these negative points as challenges to be tackled and wrestled with. A subject's ranking of his reaction to icon 35 at a level between 2 and −2 indicates intermediate levels of the ability to identify negative points in one's surroundings and to define these negative points as challenges to be tackled and wrestled with, whereby higher numerals indicate greater abilities and lower numerals indicate lesser abilities of the subject within this personality trait spectrum.

Icon 36 is formed of a pair of isosceles triangles, each being divided vertically into a pair of smaller isosceles triangles, one of which is green and the other is red. The two larger isosceles triangles are arranged with their bases parallel to one another and their peaks adjacent one another, such that a horizontal axis extends parallel to the two bases and through the junction of the two peaks. Icon 36 is symmetrical about the horizontal axis. In the sense of FIG. 1, the smaller green isosceles triangles are located to the left of the smaller red triangles.

Icon 36 relates to a personality trait spectrum representing the ability to identify the proper purpose and use of things in the world, and to use those things accordingly. A subject's ranking of his reaction to icon 36 as +2 indicates that the subject has a significant ability to identify the proper purpose and use of things in the world, and is capable of using those things accordingly. A subject's ranking of his reaction to icon 36 as −2 indicates that the subject encounters great difficulty in identifying the proper purpose and use of things, and is not able to use those things accordingly. A subject's ranking of his reaction to icon 36 at a level between 2 and −2 indicates intermediate levels of the ability to identify the proper purpose and use of things in the world, and to use those things accordingly, whereby higher numerals indicate greater abilities and lower numerals indicate lesser abilities of the subject within this personality trait spectrum.

Icon 37 is formed of a pair of isosceles triangles, one being red and the other being orange. The two triangles are arranged along a common base, and together define a square offset at a 45 degree angle from the horizontal. The square defined by the two triangles is symmetrical about a vertical axis extending between the peaks of the two isosceles triangles. In the sense of FIG. 1, the red triangle is located above the orange triangle.

Icon 37 relates to a personality trait spectrum representing the ability to completely change one's personal, social or national reality by leading a revolutionary change in one's life. A subject's ranking of his reaction to icon 37 as +2 indicates that the subject has a significant ability to completely change his reality by leading a revolutionary change in his life. A subject's ranking of his reaction to icon 37 as −2 indicates that the subject encounters great difficulty in completely changing his reality and in leading a revolutionary change in his life. A subject's ranking of his reaction to icon 37 at a level between 2 and −2 indicates intermediate levels of the ability to completely change his reality by leading a revolutionary change in his life, whereby higher numerals indicate greater abilities and lower numerals indicate lesser abilities of the subject within this personality trait spectrum.

As seen in FIG. 1, the preferred arrangement of icons also includes icons 100 and 102, which are not ranked by the subject, but rather are employed as a visual stimulation to the subject when ranking icons 1-37, and form part of the visual experience of the personality test of the present invention.

Icon 100 is a small hollow black circle, and icon 102 is formed of a plurality of circles in different colors, together forming a shape which can be delimited by a hexagon. Preferably, icon 102 includes, in clockwise direction, yellow, blue, purple, green, orange and red circles forming an outer border of the shape, and a central brown circle.

It is appreciated that each of the icons is preferably ranked by the subject individually of his ranking of any other icons, and that the combination of icons is used to analyze additional personality trait spectra only during analysis of the subject's ranking of the icons.

It will be appreciated by persons skilled in the art that the present invention is not limited to what has been particularly shown and described hereinabove. Rather the scope of the present invention includes both combinations and subcombinations of the various features described hereinabove as well as modifications and variations thereof as would occur to a person of skill in the art upon reading the foregoing specification and which are not in the prior art.

1. A method of determining personality traits of an individual comprising:
presenting to an individual a multiplicity of icons formed of geometrical shapes, said icons solely or in combination representing a plurality of personality trait spectra;
obtaining feedback from the individual as to the individual's preferences among said multiplicity of icons; and
based on the feedback obtained from the individual, determining the individual's position along at least some of said plurality of personality trait spectra.

2. A method of determining personality traits of an individual according to claim 1 and wherein said multiplicity of icons vary in at least one of shape, size and color.

3. A method of determining personality traits of an individual according to claim 1 and wherein said presenting comprises presenting via a visual display.

4. A method of determining personality traits of an individual according to claim 1 and wherein said presenting comprises presenting via a computer network.

5. A method of determining personality traits of an individual according to claim 1 and wherein said obtaining comprises communicating said feedback via a computer network.

6. A method of determining personality traits of an individual according to claim 1 and wherein said determining comprises analyzing said feedback at a location remote from said individual via a computer network.

7. A method of determining personality traits of an individual according to claim 1 and wherein said determining comprises analyzing said feedback at a location in propinquity to said individual using a computer connected to a display which is employed in said presenting.

8. A method of determining personality traits of an individual according to claim 1 and wherein said multiplicity of icons includes:
circular icons which relate generally to a first plurality of personality trait spectra; and
non-circular icons which relate generally to a second plurality of personality trait spectra, different from said first plurality of personality trait spectra.

9. A method of determining personality traits of an individual according to claim 8 and wherein said first plurality of personality trait spectra include at least two of:
will power; time efficiency; sincerity; faith; ambition; obedience; happiness; and satisfaction.

10. A method of determining personality traits of an individual according to claim 8 and wherein said second plurality of personality trait spectra include at least two of:
inventiveness; analytical ability; ability to love; compassion; confidence; appreciation; honesty; adherence to values; and discipline.

11. A method of determining personality traits of an individual according to claim 1 and wherein said multiplicity of icons comprises at least one of the following icons:
a first icon in the shape of a hollow gray circle, said first icon relating to at least one of:
a personality trait spectrum representing faith in the abstract;
a personality trait spectrum representing devotion and adherence to ideals;
a personality trait spectrum representing simplicity in perception; and
a personality trait spectrum representing freedom and independence of choice;
a second icon in the shape of a pair of hollow, dark blue isosceles triangles arranged with their bases parallel to one another and their peaks adjacent one another, said second icon relating to a personality trait spectrum representing satisfaction;
a third icon in the shape of a hollow red square, offset at a 45 degree angle from the horizontal, said third icon relating to a personality trait spectrum representing happiness;
a fourth icon in the shape of a hollow blue circle, surrounded by a plurality of blue squares forming a second circle, said fourth icon relating to a personality trait spectrum representing self-fulfillment;
a fifth icon in the shape of a hollow black square, said fifth icon relating to a personality trait spectrum representing the ability to identify and connect with things of importance or value, to define personal goals accordingly and to undertake the achievement of these goals;
a sixth icon in the shape of a hollow yellow circle, in which is nested a red circle, divided by yellow radii into twelve equal portions and having a black dot as its center, said sixth icon relating to a personality trait spectrum representing ambition and will power;
a seventh icon in the shape of a pair of large isosceles triangles, each of said large isosceles triangles comprising nine small, hollow, isosceles triangles, said nine isosceles triangles including three blue isosceles triangles, arranged along the bases of said large isosceles triangles, three dark blue isosceles triangles forming the upper boundaries of each of said large isosceles triangles and three purple isosceles triangles, the large isosceles triangles being arranged with their bases parallel to one another and their peaks adjacent one another, said seventh icon relating to at least one of:
a personality trait spectrum representing intellectual originality and inventiveness and originality of abstract thinking;
a personality trait spectrum of associative and correlative thinking in the abstract; and
a personality trait spectrum of flexibility of thinking with respect to abstract ideas;
an eighth icon in the shape of a pair of large isosceles triangles, each of said large isosceles triangles comprising nine small, hollow, isosceles triangles, each of said nine isosceles triangles being of a different color, the large isosceles triangles being arranged with their bases parallel to one another and their peaks adjacent one another, said eighth icon relating to at least one of:
a personality trait spectrum representing intellectual originality and inventiveness and originality of practical thinking;
a personality trait spectrum of associative and correlative thinking related to practical matters;
a personality trait spectrum of flexibility of thinking with respect to practical ideas and topics; and
a personality trait spectrum of intuitive decisiveness and the ability to provide intuitive arguments to support a decision made;
a ninth icon in the shape of a plurality of nested hollow squares, offset at a 45 degree angle from the horizontal and sharing a common center, said nested hollow squares being in various shades of red and orange, such that outer squares are in darker shades and inner squares are in lighter shades, each pair of adjacent ones of said plurality of squares being separated by a white square, said ninth icon relating to at least one of a personality trait spectrum representing analytical skills in the abstract;
a tenth icon in the shape of a plurality of nested hollow squares, offset at a 45 degree angle from the horizontal and sharing a common center, each of said plurality of squares being a different color such that pairs of adjacent ones of said plurality of squares being separated by a white square, said tenth icon relating to at least one of:
a personality trait spectrum representing analytical skills when faced with practical problems; and
a personality trait spectrum of logical and rational decisiveness and the ability to provide rational arguments to support a decision made;
an eleventh icon in the shape of a large square formed of sixteen small, hollow squares, including twelve black squares arranged along the edges of said large square and four yellow squares disposed in the center of said large square, said eleventh icon relating to a personality trait spectrum of cognitive acknowledgment and acceptance of moral values and of their importance;
a twelfth icon in the shape of a large square formed of sixteen small, hollow squares, including twelve squares in various shades of gray arranged along the edges of said large square, two red squares and two blue squares, said twelfth icon relating to at least one of:
a personality trait spectrum of the ability to carry out the decisions made, regardless of their origin; and
a personality trait spectrum of the ability to live by moral values and to change one's lifestyle to conform to such moral values;
a thirteenth icon in the shape of a plurality of nested hollow squares, offset at a 45 degree angle from the horizontal and sharing a common center, arranged such that an outermost square is brown, a next outermost square is maroon, a middle square is red, an innermost square is dark blue and a next innermost square is gray, each pair of ones of said plurality of squares being separated by a white square, said thirteenth icon relating to a personality trait spectrum representing wealth of intellectual vocabulary and the ability to use said vocabulary at ease;
a fourteenth icon in the shape of a plurality of nested squares, offset at a 45 degree angle from the horizontal and sharing a common center, each of said nested squares being of a different color, said fourteenth icon relating to at least one of:
a personality trait spectrum representing love and affection; and
a personality trait spectrum representing kindness and good-heartedness;
a fifteenth icon in the shape of a large square formed of sixteen smaller squares, divided into four equi-size groups of squares of the same color, said groups including dark red, red, dark pink and light pink groups, said large square being arranged such that each row and each column of said large square includes a single representative from each of said groups, said fifteenth icon relating to at least one of:
a personality trait spectrum representing emotional self-control;
a personality trait spectrum representing constructive rewarding and punishing in a proportionate manner; and
a personality trait spectrum representing courage and bravery;
a sixteenth icon in the shape of a pair of large isosceles triangles, each comprising nine small, isosceles triangles, including three light yellow isosceles triangles defining the base of each of said large triangles, three intermediate yellow isosceles triangles defining the upper boundaries of each of said large isosceles triangles and three dark yellow isosceles triangles, said large isosceles triangles being arranged with their bases parallel to one another and their peaks adjacent one another, said sixteenth icon relating to a personality trait spectrum representing compassion, mercy and empathy;
a seventeenth icon in the shape of a large square formed of sixteen smaller squares, divided into four equi-size groups of squares of the same color, said groups including squares in four shades of purple, said large square being arranged such that each row and each column of said large square includes a single representative from each of said groups, said seventeenth icon relating to at least one of:
a personality trait spectrum representing confidence; and
a personality trait spectrum of the ability to define, be attracted to and identify good and/or proper habits for oneself;
an eighteenth icon in the shape of a pair of large isosceles triangles, each comprising nine small, isosceles triangles including three light orange isosceles triangles defining the base of each of said large triangles, three dark orange isosceles triangles defining the upper boundaries of each of said large isosceles triangles and three intermediate orange isosceles triangles, said large isosceles triangles being arranged with their bases parallel to one another and their peaks adjacent one another, said eighteenth icon relating to at least one of:
a personality trait spectrum representing internal peace, quiet and calmness;
a personality trait spectrum representing the abilities of thanking, appreciating, admitting, acknowledging and giving credit;
a personality trait spectrum representing dependence and addiction; and
a personality trait spectrum of flexibility and openness to change of habits and ease of adoption of new habits;
a nineteenth icon in the shape of a plurality of nested squares, offset at a 45 degree angle from the horizontal and sharing a common center, said squares being in various shades of green such that outer squares are in darker shades of green and inner squares are in lighter shades of green, said nineteenth icon relating to at least one of:
a personality trait spectrum representing personal honesty and integrity;
a personality trait spectrum representing the abilities of forming stable and permanent personal relationships having peace and harmony; and
a personality trait spectrum of the ability to preserve and permanently maintain habits;
a twentieth icon in the shape of a pair of large isosceles triangles, each comprising nine small isosceles triangles, each being in a different color, said large isosceles triangles being arranged such that their bases are parallel to one another, and their peaks are adjacent one another, said twentieth icon relating to at least one of:
a personality trait spectrum representing natural emotional openness; and
a personality trait spectrum representing proper orientation, conduct and drive in marital connections and relationships of women;
a twenty-first icon in the shape of a plurality of nested circles sharing a common center, each being a different color, said twenty-first icon relating to at least one of:
a personality trait spectrum representing expressiveness and wealth of vocabulary available to speech;
a personality trait spectrum representing orientation, direction, motivation and drive for actions; and
a personality trait spectrum representing proper orientation, conduct and drive in marital connections and relationships of men;
a twenty-second icon in the shape of a plurality of nested circles in various shades of brown, which share a common center, arranged such that outer circles are in darker shades of brown and inner circles are in lighter shades of brown, said twenty-second icon relating to a personality trait spectrum representing humility and obedience;
a twenty-third icon in the shape of a plurality of nested hollow circles, which share a common center, arranged such that an outermost circle is brown, a next circle is maroon, a middle circle is red, an innermost circle is dark blue and a next innermost circle is gray, each pair of adjacent ones of said circles being separated by a white circle, said twenty-third icon relating to a personality trait spectrum representing focus and control of thought;
a twenty-fourth icon in the shape of a plurality of nested hollow circles of different colors, which share a common center and which are arranged such that each pair of adjacent ones of said plurality of circles is separated by a white circle, said twenty-fourth icon relating to a personality trait spectrum representing behavior of speech;
a twenty-fifth icon in the shape of a plurality of nested hollow circles in various shades of brown, which share a common center and are arranged such that outer circles are in darker shades of brown and inner circles are in lighter shades of brown, each pair of adjacent ones of said plurality of circles being separated by a white circle, said twenty-fifth icon relating to a personality trait spectrum representing behavior of actions;
a twenty-sixth icon in the shape of a pair of isosceles triangles, one being purple and the other being yellow, arranged along a common base to define a square offset at a 45 degree angle from the horizontal and symmetrical about a vertical axis extending between the peaks of said isosceles triangles, said twenty-sixth icon relating to a personality trait spectrum representing the sense of conversation;
a twenty-seventh icon in the shape of a pair of isosceles triangles, one being red and the other being yellow, arranged along a common base to define a square offset at a 45 degree angle from the horizontal and symmetrical about a horizontal axis extending between the peaks of said isosceles triangles, said twenty-seventh icon relating to a personality trait spectrum representing the sense of contemplation;
a twenty-eighth icon in the shape of a pair of isosceles triangles, one being orange and the other being yellow, arranged with their bases parallel to one another and their peaks adjacent one another, said twenty-eighth icon relating to a personality trait spectrum representing the sense of motion;
a twenty-ninth icon in the shape of a pair of isosceles triangles, one being purple and the other being blue, arranged with their bases parallel to one another and their peaks adjacent one another, said twenty-ninth icon relating to a personality trait spectrum representing the sense of realistic vision and sight;
a thirtieth icon in the shape of a pair of rectangles, one being yellow and the other being blue, arranged along a common edge to define a square which is symmetrical about a horizontal axis extending through its center, said thirtieth icon relating to a personality trait spectrum representing optimism;
a thirty-first icon in the shape of a pair of rectangles, one being blue and the other being orange, arranged along a common edge to define a square which is symmetrical about a vertical axis extending through its center, said thirty-first icon relating to a personality trait spectrum representing the ability of correction and solving of problems;
a thirty-second icon in the shape of a pair of isosceles triangles, one being purple and the other being green, arranged with their bases parallel to one another and their peaks adjacent one another, said thirty-second icon relating to a personality trait spectrum representing the ability to push things forward;
a thirty-third icon in the shape of a pair of isosceles triangles, one being blue and the other being green, arranged along a common base to define a square offset at a 45 degree angle from the horizontal and symmetrical about a horizontal axis extending between the peaks of said isosceles triangles, said thirty-third icon relating to a personality trait spectrum representing the sense of timing;
a thirty-fourth icon in the shape of a pair of rectangles, one being green and the other being orange, arranged along a common edge to define a square which is symmetrical about a vertical axis extending through its center, said thirty-fourth icon relating to a personality trait spectrum representing the ability to influence others;
a thirty-fifth icon in the shape of a pair of rectangles, one being purple and the other being red, arranged along a common edge to define a square which is symmetrical about a vertical axis extending through its center, said thirty-fifth icon relating to a personality trait spectrum representing the ability to identify negative points in one's surroundings and to define said negative points as challenges to be tackled and wrestled with;
a thirty-sixth icon in the shape of a pair of large isosceles triangles, each being divided vertically into a pair of small isosceles triangles, one of which is green and the other is red, said large isosceles triangles being arranged with their bases parallel to one another and their peaks adjacent one another, said thirty-sixth icon relating to a personality trait spectrum representing the ability to identify the proper purpose and use of things in the world, and to use said things accordingly; and
a thirty-seventh icon in the shape of a pair of isosceles triangles, one being red and the other being orange, arranged along a common base to define a square offset at a 45 degree angle from the horizontal and symmetrical about a vertical axis extending between the peaks of said isosceles triangles, said thirty-seventh icon relating to a personality trait spectrum representing the ability to completely change one's personal, social and national reality by leading a revolutionary change in one's life.

12. A test for determining personality traits of an individual comprising:
a display including a multiplicity of icons formed of geometrical shapes, said icons solely or in combination representing a plurality of personality trait spectra;
feedback functionality operative to obtain feedback from the individual as to the individual's preferences among said multiplicity of icons; and
feedback analysis functionality operative, based on the feedback obtained from the individual, to determine the individual's position along at least some of said plurality of personality trait spectra.

13. A test for determining personality traits of an individual according to claim 12 and wherein said multiplicity of icons vary in at least one of shape, size and color.

14. A test for determining personality traits of an individual according to claim 12 and wherein said display is a computer driven display.

15. A test for determining personality traits of an individual according to claim 12 and wherein at least one of said feedback functionality and said feedback analysis functionality employs a computer network.

16. A test for determining personality traits of an individual according to claim 12 and wherein said feedback functionality communicates with said feedback analysis functionality via a computer network.

17. A test for determining personality traits of an individual according to claim 12 and wherein said feedback analysis functionality is located remotely from said individual and communicates with said individual via a computer network.

18. A test for determining personality traits of an individual according to claim 12 and wherein said feedback analysis functionality is located in propinquity to said individual and employs a computer associated with said display.

19. A test for determining personality traits of an individual according to claim 12 and wherein said multiplicity of icons comprises at least one of the following icons:
a first icon in the shape of a hollow gray circle, said first icon relating to at least one of:
a personality trait spectrum representing faith in the abstract;
a personality trait spectrum representing devotion and adherence to ideals;
a personality trait spectrum representing simplicity in perception; and
a personality trait spectrum representing freedom and independence of choice;
a second icon in the shape of a pair of hollow, dark blue isosceles triangles arranged with their bases parallel to one another and their peaks adjacent one another, said second icon relating to a personality trait spectrum representing satisfaction;
a third icon in the shape of a hollow red square, offset at a 45 degree angle from the horizontal, said third icon relating to a personality trait spectrum representing happiness;
a fourth icon in the shape of a hollow blue circle, surrounded by a plurality of blue squares forming a second circle, said fourth icon relating to a personality trait spectrum representing self-fulfillment;
a fifth icon in the shape of a hollow black square, said fifth icon relating to a personality trait spectrum representing the ability to identify and connect with things of importance or value, to define personal goals accordingly and to undertake the achievement of these goals;
a sixth icon in the shape of a hollow yellow circle, in which is nested a red circle, divided by yellow radii into twelve equal portions and having a black dot as its center, said sixth icon relating to a personality trait spectrum representing ambition and will power;
a seventh icon in the shape of a pair of large isosceles triangles, each of said large isosceles triangles comprising nine small, hollow, isosceles triangles, said nine isosceles triangles including three blue isosceles triangles, arranged along the bases of said large isosceles triangles, three dark blue isosceles triangles forming the upper boundaries of each of said large isosceles triangles and three purple isosceles triangles, the large isosceles triangles being arranged with their bases parallel to one another and their peaks adjacent one another, said seventh icon relating to at least one of:
a personality trait spectrum representing intellectual originality and inventiveness and originality of abstract thinking;
a personality trait spectrum of associative and correlative thinking in the abstract; and
a personality trait spectrum of flexibility of thinking with respect to abstract ideas;
an eighth icon in the shape of a pair of large isosceles triangles, each of said large isosceles triangles comprising nine small, hollow, isosceles triangles, each of said nine isosceles triangles being of a different color, the large isosceles triangles being arranged with their bases parallel to one another and their peaks adjacent one another, said eighth icon relating to at least one of:
a personality trait spectrum representing intellectual originality and inventiveness and originality of practical thinking;
a personality trait spectrum of associative and correlative thinking related to practical matters;
a personality trait spectrum of flexibility of thinking with respect to practical ideas and topics; and
a personality trait spectrum of intuitive decisiveness and the ability to provide intuitive arguments to support a decision made;
a ninth icon in the shape of a plurality of nested hollow squares, offset at a 45 degree angle from the horizontal and sharing a common center, said nested hollow squares being in various shades of red and orange, such that outer squares are in darker shades and inner squares are in lighter shades, each pair of adjacent ones of said plurality of squares being separated by a white square, said ninth icon relating to at least one of a personality trait spectrum representing analytical skills in the abstract;
a tenth icon in the shape of a plurality of nested hollow squares, offset at a 45 degree angle from the horizontal and sharing a common center, each of said plurality of squares being a different color such that pairs of adjacent ones of said plurality of squares being separated by a white square, said tenth icon relating to at least one of:
a personality trait spectrum representing analytical skills when faced with practical problems; and
a personality trait spectrum of logical and rational decisiveness and the ability to provide rational arguments to support a decision made;
an eleventh icon in the shape of a large square formed of sixteen small, hollow squares, including twelve black squares arranged along the edges of said large square and four yellow squares disposed in the center of said large square, said eleventh icon relating to a personality trait spectrum of cognitive acknowledgment and acceptance of moral values and of their importance;
a twelfth icon in the shape of a large square formed of sixteen small, hollow squares, including twelve squares in various shades of gray arranged along the edges of said large square, two red squares and two blue squares, said twelfth icon relating to at least one of:
a personality trait spectrum of the ability to carry out the decisions made, regardless of their origin; and
a personality trait spectrum of the ability to live by moral values and to change one's lifestyle to conform to such moral values;
a thirteenth icon in the shape of a plurality of nested hollow squares, offset at a 45 degree angle from the horizontal and sharing a common center, arranged such that an outermost square is brown, a next outermost square is maroon, a middle square is red, an innermost square is dark blue and a next innermost square is gray, each pair of ones of said plurality of squares being separated by a white square, said thirteenth icon relating to a personality trait spectrum representing wealth of intellectual vocabulary and the ability to use said vocabulary at ease;
a fourteenth icon in the shape of a plurality of nested squares, offset at a 45 degree angle from the horizontal and sharing a common center, each of said nested squares being of a different color, said fourteenth icon relating to at least one of:
a personality trait spectrum representing love and affection; and
a personality trait spectrum representing kindness and good-heartedness;
a fifteenth icon in the shape of a large square formed of sixteen smaller squares, divided into four equi-size groups of squares of the same color, said groups including dark red, red, dark pink and light pink groups, said large square being arranged such that each row and each column of said large square includes a single representative from each of said groups, said fifteenth icon relating to at least one of:
a personality trait spectrum representing emotional self-control;
a personality trait spectrum representing constructive rewarding and punishing in a proportionate manner; and
a personality trait spectrum representing courage and bravery;
a sixteenth icon in the shape of a pair of large isosceles triangles, each comprising nine small, isosceles triangles, including three light yellow isosceles triangles defining the base of each of said large triangles, three intermediate yellow isosceles triangles defining the upper boundaries of each of said large isosceles triangles and three dark yellow isosceles triangles, said large isosceles triangles being arranged with their bases parallel to one another and their peaks adjacent one another, said sixteenth icon relating to a personality trait spectrum representing compassion, mercy and empathy;
a seventeenth icon in the shape of a large square formed of sixteen smaller squares, divided into four equi-size groups of squares of the same color, said groups including squares in four shades of purple, said large square being arranged such that each row and each column of said large square includes a single representative from each of said groups, said seventeenth icon relating to at least one of:
a personality trait spectrum representing confidence; and
a personality trait spectrum of the ability to define, be attracted to and identify good and/or proper habits for oneself;
an eighteenth icon in the shape of a pair of large isosceles triangles, each comprising nine small, isosceles triangles including three light orange isosceles triangles defining the base of each of said large triangles, three dark orange isosceles triangles defining the upper boundaries of each of said large isosceles triangles and three intermediate orange isosceles triangles, said large isosceles triangles being arranged with their bases parallel to one another and their peaks adjacent one another, said eighteenth icon relating to at least one of:
a personality trait spectrum representing internal peace, quiet and calmness;
a personality trait spectrum representing the abilities of thanking, appreciating, admitting, acknowledging and giving credit;
a personality trait spectrum representing dependence and addiction; and
a personality trait spectrum of flexibility and openness to change of habits and ease of adoption of new habits;
a nineteenth icon in the shape of a plurality of nested squares, offset at a 45 degree angle from the horizontal and sharing a common center, said squares being in various shades of green such that outer squares are in darker shades of green and inner squares are in lighter shades of green, said nineteenth icon relating to at least one of:
a personality trait spectrum representing personal honesty and integrity;
a personality trait spectrum representing the abilities of forming stable and permanent personal relationships having peace and harmony; and
a personality trait spectrum of the ability to preserve and permanently maintain habits;
a twentieth icon in the shape of a pair of large isosceles triangles, each comprising nine small isosceles triangles, each being in a different color, said large isosceles triangles being arranged such that their bases are parallel to one another, and their peaks are adjacent one another, said twentieth icon relating to at least one of:
a personality trait spectrum representing natural emotional openness; and
a personality trait spectrum representing proper orientation, conduct and drive in marital connections and relationships of women;
a twenty-first icon in the shape of a plurality of nested circles sharing a common center, each being a different color, said twenty-first icon relating to at least one of:
a personality trait spectrum representing expressiveness and wealth of vocabulary available to speech;
a personality trait spectrum representing orientation, direction, motivation and drive for actions; and
a personality trait spectrum representing proper orientation, conduct and drive in marital connections and relationships of men;
a twenty-second icon in the shape of a plurality of nested circles in various shades of brown, which share a common center, arranged such that outer circles are in darker shades of brown and inner circles are in lighter shades of brown, said twenty-second icon relating to a personality trait spectrum representing humility and obedience;
a twenty-third icon in the shape of a plurality of nested hollow circles, which share a common center, arranged such that an outermost circle is brown, a next circle is maroon, a middle circle is red, an innermost circle is dark blue and a next innermost circle is gray, each pair of adjacent ones of said circles being separated by a white circle, said twenty-third icon relating to a personality trait spectrum representing focus and control of thought;
a twenty-fourth icon in the shape of a plurality of nested hollow circles of different colors, which share a common center and which are arranged such that each pair of adjacent ones of said plurality of circles is separated by a white circle, said twenty-fourth icon relating to a personality trait spectrum representing behavior of speech;
a twenty-fifth icon in the shape of a plurality of nested hollow circles in various shades of brown, which share a common center and are arranged such that outer circles are in darker shades of brown and inner circles are in lighter shades of brown, each pair of adjacent ones of said plurality of circles being separated by a white circle, said twenty-fifth icon relating to a personality trait spectrum representing behavior of actions;
a twenty-sixth icon in the shape of a pair of isosceles triangles, one being purple and the other being yellow, arranged along a common base to define a square offset at a 45 degree angle from the horizontal and symmetrical about a vertical axis extending between the peaks of said isosceles triangles, said twenty-sixth icon relating to a personality trait spectrum representing the sense of conversation;
a twenty-seventh icon in the shape of a pair of isosceles triangles, one being red and the other being yellow, arranged along a common base to define a square offset at a 45 degree angle from the horizontal and symmetrical about a horizontal axis extending between the peaks of said isosceles triangles, said twenty-seventh icon relating to a personality trait spectrum representing the sense of contemplation;
a twenty-eighth icon in the shape of a pair of isosceles triangles, one being orange and the other being yellow, arranged with their bases parallel to one another and their peaks adjacent one another, said twenty-eighth icon relating to a personality trait spectrum representing the sense of motion;
a twenty-ninth icon in the shape of a pair of isosceles triangles, one being purple and the other being blue, arranged with their bases parallel to one another and their peaks adjacent one another, said twenty-ninth icon relating to a personality trait spectrum representing the sense of realistic vision and sight;
a thirtieth icon in the shape of a pair of rectangles, one being yellow and the other being blue, arranged along a common edge to define a square which is symmetrical about a horizontal axis extending through its center, said thirtieth icon relating to a personality trait spectrum representing optimism;
a thirty-first icon in the shape of a pair of rectangles, one being blue and the other being orange, arranged along a common edge to define a square which is symmetrical about a vertical axis extending through its center, said thirty-first icon relating to a personality trait spectrum representing the ability of correction and solving of problems;
a thirty-second icon in the shape of a pair of isosceles triangles, one being purple and the other being green, arranged with their bases parallel to one another and their peaks adjacent one another, said thirty-second icon relating to a personality trait spectrum representing the ability to push things forward;
a thirty-third icon in the shape of a pair of isosceles triangles, one being blue and the other being green, arranged along a common base to define a square offset at a 45 degree angle from the horizontal and symmetrical about a horizontal axis extending between the peaks of said isosceles triangles, said thirty-third icon relating to a personality trait spectrum representing the sense of timing;
a thirty-fourth icon in the shape of a pair of rectangles, one being green and the other being orange, arranged along a common edge to define a square which is symmetrical about a vertical axis extending through its center, said thirty-fourth icon relating to a personality trait spectrum representing the ability to influence others;
a thirty-fifth icon in the shape of a pair of rectangles, one being purple and the other being red, arranged along a common edge to define a square which is symmetrical about a vertical axis extending through its center, said thirty-fifth icon relating to a personality trait spectrum representing the ability to identify negative points in one's surroundings and to define said negative points as challenges to be tackled and wrestled with;
a thirty-sixth icon in the shape of a pair of large isosceles triangles, each being divided vertically into a pair of small isosceles triangles, one of which is green and the other is red, said large isosceles triangles being arranged with their bases parallel to one another and their peaks adjacent one another, said thirty-sixth icon relating to a personality trait spectrum representing the ability to identify the proper purpose and use of things in the world, and to use said things accordingly; and
a thirty-seventh icon in the shape of a pair of isosceles triangles, one being red and the other being orange, arranged along a common base to define a square offset at a 45 degree angle from the horizontal and symmetrical about a vertical axis extending between the peaks of said isosceles triangles, said thirty-seventh icon relating to a personality trait spectrum representing the ability to completely change one's personal, social and national reality by leading a revolutionary change in one's life.

20. A visual presentation useful in determining personality traits of an individual comprising:
a display of a multiplicity of icons formed of geometrical shapes, said icons solely or in combination representing a plurality of personality trait spectra, said display being viewable by an individual who is enabled to provide feedback as to the individual's preferences among said multiplicity of icons, which feedback is useful to determine the individual's position along at least some of said plurality of personality trait spectra.

21. A visual presentation according to claim 20 and wherein said multiplicity of icons vary in at least one of shape, size and color.

22. A visual presentation useful in determining personality traits of an individual according to claim 20 and wherein said multiplicity of icons comprises at least one of the following icons:
a first icon in the shape of a hollow gray circle, said first icon relating to at least one of:
a personality trait spectrum representing faith in the abstract;
a personality trait spectrum representing devotion and adherence to ideals;
a personality trait spectrum representing simplicity in perception; and
a personality trait spectrum representing freedom and independence of choice;
a second icon in the shape of a pair of hollow, dark blue isosceles triangles arranged with their bases parallel to one another and their peaks adjacent one another, said second icon relating to a personality trait spectrum representing satisfaction;
a third icon in the shape of a hollow red square, offset at a 45 degree angle from the horizontal, said third icon relating to a personality trait spectrum representing happiness;
a fourth icon in the shape of a hollow blue circle, surrounded by a plurality of blue squares forming a second circle, said fourth icon relating to a personality trait spectrum representing self-fulfillment;
a fifth icon in the shape of a hollow black square, said fifth icon relating to a personality trait spectrum representing the ability to identify and connect with things of importance or value, to define personal goals accordingly and to undertake the achievement of these goals;
a sixth icon in the shape of a hollow yellow circle, in which is nested a red circle, divided by yellow radii into twelve equal portions and having a black dot as its center, said sixth icon relating to a personality trait spectrum representing ambition and will power;
a seventh icon in the shape of a pair of large isosceles triangles, each of said large isosceles triangles comprising nine small, hollow, isosceles triangles, said nine isosceles triangles including three blue isosceles triangles, arranged along the bases of said large isosceles triangles, three dark blue isosceles triangles forming the upper boundaries of each of said large isosceles triangles and three purple isosceles triangles, the large isosceles triangles being arranged with their bases parallel to one another and their peaks adjacent one another, said seventh icon relating to at least one of:
a personality trait spectrum representing intellectual originality and inventiveness and originality of abstract thinking;
a personality trait spectrum of associative and correlative thinking in the abstract; and
a personality trait spectrum of flexibility of thinking with respect to abstract ideas;
an eighth icon in the shape of a pair of large isosceles triangles, each of said large isosceles triangles comprising nine small, hollow, isosceles triangles, each of said nine isosceles triangles being of a different color, the large isosceles triangles being arranged with their bases parallel to one another and their peaks adjacent one another, said eighth icon relating to at least one of:
a personality trait spectrum representing intellectual originality and inventiveness and originality of practical thinking;
a personality trait spectrum of associative and correlative thinking related to practical matters;
a personality trait spectrum of flexibility of thinking with respect to practical ideas and topics; and
a personality trait spectrum of intuitive decisiveness and the ability to provide intuitive arguments to support a decision made;
a ninth icon in the shape of a plurality of nested hollow squares, offset at a 45 degree angle from the horizontal and sharing a common center, said nested hollow squares being in various shades of red and orange, such that outer squares are in darker shades and inner squares are in lighter shades, each pair of adjacent ones of said plurality of squares being separated by a white square, said ninth icon relating to at least one of a personality trait spectrum representing analytical skills in the abstract;
a tenth icon in the shape of a plurality of nested hollow squares, offset at a 45 degree angle from the horizontal and sharing a common center, each of said plurality of squares being a different color such that pairs of adjacent ones of said plurality of squares being separated by a white square, said tenth icon relating to at least one of:
a personality trait spectrum representing analytical skills when faced with practical problems; and
a personality trait spectrum of logical and rational decisiveness and the ability to provide rational arguments to support a decision made;
an eleventh icon in the shape of a large square formed of sixteen small, hollow squares, including twelve black squares arranged along the edges of said large square and four yellow squares disposed in the center of said large square, said eleventh icon relating to a personality trait spectrum of cognitive acknowledgment and acceptance of moral values and of their importance;
a twelfth icon in the shape of a large square formed of sixteen small, hollow squares, including twelve squares in various shades of gray arranged along the edges of said large square, two red squares and two blue squares, said twelfth icon relating to at least one of:
a personality trait spectrum of the ability to carry out the decisions made, regardless of their origin; and
a personality trait spectrum of the ability to live by moral values and to change one's lifestyle to conform to such moral values;
a thirteenth icon in the shape of a plurality of nested hollow squares, offset at a 45 degree angle from the horizontal and sharing a common center, arranged such that an outermost square is brown, a next outermost square is maroon, a middle square is red, an innermost square is dark blue and a next innermost square is gray, each pair of ones of said plurality of squares being separated by a white square, said thirteenth icon relating to a personality trait spectrum representing wealth of intellectual vocabulary and the ability to use said vocabulary at ease;
a fourteenth icon in the shape of a plurality of nested squares, offset at a 45 degree angle from the horizontal and sharing a common center, each of said nested squares being of a different color, said fourteenth icon relating to at least one of:
a personality trait spectrum representing love and affection; and
a personality trait spectrum representing kindness and good-heartedness;
a fifteenth icon in the shape of a large square formed of sixteen smaller squares, divided into four equi-size groups of squares of the same color, said groups including dark red, red, dark pink and light pink groups, said large square being arranged such that each row and each column of said large square includes a single representative from each of said groups, said fifteenth icon relating to at least one of:
a personality trait spectrum representing emotional self-control;
a personality trait spectrum representing constructive rewarding and punishing in a proportionate manner; and
a personality trait spectrum representing courage and bravery;
a sixteenth icon in the shape of a pair of large isosceles triangles, each comprising nine small, isosceles triangles, including three light yellow isosceles triangles defining the base of each of said large triangles, three intermediate yellow isosceles triangles defining the upper boundaries of each of said large isosceles triangles and three dark yellow isosceles triangles, said large isosceles triangles being arranged with their bases parallel to one another and their peaks adjacent one another, said sixteenth icon relating to a personality trait spectrum representing compassion, mercy and empathy;
a seventeenth icon in the shape of a large square formed of sixteen smaller squares, divided into four equi-size groups of squares of the same color, said groups including squares in four shades of purple, said large square being arranged such that each row and each column of said large square includes a single representative from each of said groups, said seventeenth icon relating to at least one of:
a personality trait spectrum representing confidence; and
a personality trait spectrum of the ability to define, be attracted to and identify good and/or proper habits for oneself;
an eighteenth icon in the shape of a pair of large isosceles triangles, each comprising nine small, isosceles triangles including three light orange isosceles triangles defining the base of each of said large triangles, three dark orange isosceles triangles defining the upper boundaries of each of said large isosceles triangles and three intermediate orange isosceles triangles, said large isosceles triangles being arranged with their bases parallel to one another and their peaks adjacent one another, said eighteenth icon relating to at least one of:
a personality trait spectrum representing internal peace, quiet and calmness;
a personality trait spectrum representing the abilities of thanking, appreciating, admitting, acknowledging and giving credit;
a personality trait spectrum representing dependence and addiction; and
a personality trait spectrum of flexibility and openness to change of habits and ease of adoption of new habits;
a nineteenth icon in the shape of a plurality of nested squares, offset at a 45 degree angle from the horizontal and sharing a common center, said squares being in various shades of green such that outer squares are in darker shades of green and inner squares are in lighter shades of green, said nineteenth icon relating to at least one of:
a personality trait spectrum representing personal honesty and integrity;
a personality trait spectrum representing the abilities of forming stable and permanent personal relationships having peace and harmony; and
a personality trait spectrum of the ability to preserve and permanently maintain habits;
a twentieth icon in the shape of a pair of large isosceles triangles, each comprising nine small isosceles triangles, each being in a different color, said large isosceles triangles being arranged such that their bases are parallel to one another, and their peaks are adjacent one another, said twentieth icon relating to at least one of:
a personality trait spectrum representing natural emotional openness; and
a personality trait spectrum representing proper orientation, conduct and drive in marital connections and relationships of women;
a twenty-first icon in the shape of a plurality of nested circles sharing a common center, each being a different color, said twenty-first icon relating to at least one of:
a personality trait spectrum representing expressiveness and wealth of vocabulary available to speech;
a personality trait spectrum representing orientation, direction, motivation and drive for actions; and
a personality trait spectrum representing proper orientation, conduct and drive in marital connections and relationships of men;
a twenty-second icon in the shape of a plurality of nested circles in various shades of brown, which share a common center, arranged such that outer circles are in darker shades of brown and inner circles are in lighter shades of brown, said twenty-second icon relating to a personality trait spectrum representing humility and obedience;
a twenty-third icon in the shape of a plurality of nested hollow circles, which share a common center, arranged such that an outermost circle is brown, a next circle is maroon, a middle circle is red, an innermost circle is dark blue and a next innermost circle is gray, each pair of adjacent ones of said circles being separated by a white circle, said twenty-third icon relating to a personality trait spectrum representing focus and control of thought;
a twenty-fourth icon in the shape of a plurality of nested hollow circles of different colors, which share a common center and which are arranged such that each pair of adjacent ones of said plurality of circles is separated by a white circle, said twenty-fourth icon relating to a personality trait spectrum representing behavior of speech;
a twenty-fifth icon in the shape of a plurality of nested hollow circles in various shades of brown, which share a common center and are arranged such that outer circles are in darker shades of brown and inner circles are in lighter shades of brown, each pair of adjacent ones of said plurality of circles being separated by a white circle, said twenty-fifth icon relating to a personality trait spectrum representing behavior of actions;
a twenty-sixth icon in the shape of a pair of isosceles triangles, one being purple and the other being yellow, arranged along a common base to define a square offset at a 45 degree angle from the horizontal and symmetrical about a vertical axis extending between the peaks of said isosceles triangles, said twenty-sixth icon relating to a personality trait spectrum representing the sense of conversation;
a twenty-seventh icon in the shape of a pair of isosceles triangles, one being red and the other being yellow, arranged along a common base to define a square offset at a 45 degree angle from the horizontal and symmetrical about a horizontal axis extending between the peaks of said isosceles triangles, said twenty-seventh icon relating to a personality trait spectrum representing the sense of contemplation;
a twenty-eighth icon in the shape of a pair of isosceles triangles, one being orange and the other being yellow, arranged with their bases parallel to one another and their peaks adjacent one another, said twenty-eighth icon relating to a personality trait spectrum representing the sense of motion;
a twenty-ninth icon in the shape of a pair of isosceles triangles, one being purple and the other being blue, arranged with their bases parallel to one another and their peaks adjacent one another, said twenty-ninth icon relating to a personality trait spectrum representing the sense of realistic vision and sight;
a thirtieth icon in the shape of a pair of rectangles, one being yellow and the other being blue, arranged along a common edge to define a square which is symmetrical about a horizontal axis extending through its center, said thirtieth icon relating to a personality trait spectrum representing optimism;
a thirty-first icon in the shape of a pair of rectangles, one being blue and the other being orange, arranged along a common edge to define a square which is symmetrical about a vertical axis extending through its center, said thirty-first icon relating to a personality trait spectrum representing the ability of correction and solving of problems;
a thirty-second icon in the shape of a pair of isosceles triangles, one being purple and the other being green, arranged with their bases parallel to one another and their peaks adjacent one another, said thirty-second icon relating to a personality trait spectrum representing the ability to push things forward;
a thirty-third icon in the shape of a pair of isosceles triangles, one being blue and the other being green, arranged along a common base to define a square offset at a 45 degree angle from the horizontal and symmetrical about a horizontal axis extending between the peaks of said isosceles triangles, said thirty-third icon relating to a personality trait spectrum representing the sense of timing;
a thirty-fourth icon in the shape of a pair of rectangles, one being green and the other being orange, arranged along a common edge to define a square which is symmetrical about a vertical axis extending through its center, said thirty-fourth icon relating to a personality trait spectrum representing the ability to influence others;
a thirty-fifth icon in the shape of a pair of rectangles, one being purple and the other being red, arranged along a common edge to define a square which is symmetrical about a vertical axis extending through its center, said thirty-fifth icon relating to a personality trait spectrum representing the ability to identify negative points in one's surroundings and to define said negative points as challenges to be tackled and wrestled with;
a thirty-sixth icon in the shape of a pair of large isosceles triangles, each being divided vertically into a pair of small isosceles triangles, one of which is green and the other is red, said large isosceles triangles being arranged with their bases parallel to one another and their peaks adjacent one another, said thirty-sixth icon relating to a personality trait spectrum representing the ability to identify the proper purpose and use of things in the world, and to use said things accordingly; and
a thirty-seventh icon in the shape of a pair of isosceles triangles, one being red and the other being orange, arranged along a common base to define a square offset at a 45 degree angle from the horizontal and symmetrical about a vertical axis extending between the peaks of said isosceles triangles, said thirty-seventh icon relating to a personality trait spectrum representing the ability to completely change one's personal, social and national reality by leading a revolutionary change in one's life.
